(19) United States
(12) Patent Application Publication
(10) Pub. No.: US 2005/0040637 A1
(43) Pub. Date: Feb. 24, 2005

(54) Undercarriage flow control device and method for reducing the aerodynamic drag of ground vehicles

(76) Inventor: Richard M. Wood, Virginia Beach, VA (US)

Correspondence Address: Richard M. Wood, 754 Suffolk Lane, Virginia Beach, VA, 23452, US

(21) Appl. No.: 10/914,670

(22) Filed: Aug. 10, 2004

Related U.S. Application Data
(60) Provisional application No. 60/496,852, filed on Aug. 21, 2003.

(51) Int. Cl. B60R 1/00

(52) U.S. Cl. 280/768

(57) ABSTRACT

An improved method and device for the reduction of aerodynamic drag and for improved performance of ground vehicles by increasing the pressure on the base area of a bluff-base ground vehicle or vehicle component by conditioning the undercarriage flow and controlling the discharge of the undercarriage flow into the trailing wake of a ground vehicle. The subject invention provides an improved method and device for generating a reduction in the drag force on a bluff-base object moving through air. The apparatus consists of aerodynamically shaped surfaces that are attached to the undercarriage of a vehicle between the base area and the aft most set of wheels. The surfaces are shaped and positioned such that they may be combined with the vehicle lower surface and the ground to form a nozzle with the smallest opening located at the aft end of the vehicle and the largest opening located forward of the smallest opening. The largest opening has a width that is equivalent to the width of the vehicle and has a height that is approximately equal to the distance between the vehicle lower surface and the ground. The smallest opening is located at the base of the vehicle and has an area and shaped opening to maximize the discharge of the undercarriage flow into the wake. The surfaces that comprise the invention are aerodynamically shaped to minimize separation of the flow passing through the device and on the outer surface of the device and at the same time, to increase the momentum for the flow passing through the device and to entraining additional air externally to the device. The reduction in drag force results from the increase in pressure acting on the base area of the vehicle. The increase in base pressure is a result of the increase in wake energy and reduction in the unsteady wake flow due to the addition of the high momentum undercarriage flow into the wake. The objects and advantages also extend to other applications in which an object or vehicle is moving through either a gas or fluid.

### CROSS-REFERENCE TO RELATED APPLICATIONS

This application claims a previous provisional patent application, No. 60/496,852 with a filing date of Aug. 21, 2003 and entitled “Undercarriage flow control device and method for reducing the aerodynamic drag of ground vehicles”.

### ORIGIN OF THE INVENTION

The invention described herein was made by employees of the United States Government, and may be manufactured and used by or for the Government without payment of any royalties thereon or therefore.

### REFERENCE TO SEQUENCE LISTING, A TABLE, OR A COMPUTER PROGRAM LISTING COMPACT DISK APPENDIX

Not applicable.

### BACKGROUND

1. Field of Invention

The invention relates to the reduction of aerodynamic drag for moving ground vehicles; specifically to an improved method and device for the reduction of aerodynamic drag and for improved performance of ground vehicles by increasing the pressure on the base area of a vehicle or vehicle component by controlling the wake flow of a bluff-base vehicle or vehicle component. The invention also relates to reducing the splash and spray from the wheels, undercarriage and bluff-base wake flow.

2. Description of Prior Art

Solutions to ground vehicle flow problems are extremely unique in that the solutions must address not only free-stream aerodynamics but must also take into account ground effects, rotating flows induced by wheels, large-scale turbulence structures from the undercarriage, large temperature gradients, braking requirements, cross-flow instabilities, environmental effects, near vehicle interference effects, brake cooling requirements, environmental concerns, aesthetics, loading/docking requirements, maintenance, and a host of other issues unique to the ground transportation industry.

In the prior art there have been attempts to reduce the aerodynamic drag associated with the bluff base of the trailer of a tractor-trailer truck system. The wake flow emanating from the bluff-base trailer is characterized as unsteady and dynamic. The unsteady nature of the wake flow is a result of asymmetric and oscillatory vortex shedding of the flow at the juncture of the side surfaces and top surface with the bluff-base surface and the turbulent flow that exits from the vehicle undercarriage at the base of the vehicle.

The boundary-layer flow passing along the top and side surfaces of the vehicle is at a low energy state and is unable to expand around the corner defined by the intersection of the side surfaces or top surface with the base surface. The boundary-layer flow separates at the trailing edge of the top and side surfaces and forms rotational-flow structures that contribute to the bluff-base wake flow. The low energy flow separating at the trailing edges of the side surfaces and top surface of the trailer is unable to energize and stabilize the low energy bluff-base wake flow. Contributing to the low-energy bluff-base wake is the low-energy turbulent flow that exits from the vehicle undercarriage at the base of the vehicle. The unsteady bluff-base wake flow imparts a low pressure onto the aft facing surface of the trailer base that results in significant aerodynamic drag. The unsteady low-energy turbulent undercarriage flow and bluff-base flow also produce water splash and spray as well as adverse wind buffeting that are safety hazards to other vehicles on the road.

There is no known prior art that performs the function of the subject invention, however, a wide range of devices and concepts have been developed to control the base flow of bluff-base ground vehicles. Previous concepts have been active devices that attempted to inhibit separation on the base to create a predetermined “best” situation. Prior art has addressed these adverse bluff-base and undercarriage flow phenomena by replacing the bluff base with a pre-defined aerodynamic surface, with panels and plates that are added to the bluff base to create an alternate bluff-base geometry or by controlling and energizing the flow exiting the top surface and side surfaces trailing edge of the vehicle and forcing this flow into the base region through the use of turning vanes or jets of air.

Prior art has consisted of either drag reduction devices or splash and spray control devices. The drag reduction devices usually consisted of boat tails, extension panels, forced venting systems, and boundary-layer control devices. Prior drag reduction art has used the aerodynamic boat-tail fairings applied to the trailer base in order to eliminate flow separation and associated drag, see U.S. Pat. Nos. 4,458,936, 4,601,508, 4,006,932, 4,451,074, 6,092,861, 4,741,569, 4,257,641, 4,508,380, 4,978,162 and 2,737,411. These representative aerodynamic boat-tail fairing devices, while successful in eliminating flow separation, are complex devices that are typically comprised of moving parts that require maintenance and add weight to the vehicle. These devices take a variety of form and may be active, passive, rigid, flexible and/or inflatable. These attributes have a negative impact on operational performance and interfere with normal operations of the vehicle.

Other drag reduction concepts as documented in U.S. Pat. Nos. 5,348,366, 4,682,808 and 421,478 consist of plates or panels that are attached to the base of a trailer or extend from support mechanisms that are attached to the base of a trailer. These devices operate by trapping the separated flow in a preferred position in order to create an effective aerodynamic boat-tail shape. These representative trailer base devices, while successful in reducing the drag due to base flow are complex devices that are typically comprised of moving parts that require maintenance and add weight to the vehicle. All of these devices add significant weight to the vehicle. These attributes have a negative impact on operational performance and interfere with normal operations of the vehicle.

U.S. Pat. Nos. 3,010,754, 5,280,990, 2,569,983 and 3,999,797 are drag reduction devices that apply a flow turning vane to the outer perimeter of the trailer base on the sides and top to direct the flow passing over the sides and top of the trailer into the wake in order to minimize the drag penalty of the trailer base flow. These devices provide a drag reduction benefit but they require maintenance and interfere with normal operations of the trailers fitted with swinging doors. These devices also add weight to the vehicle that would have a negative impact on operational performance of the vehicle.

Several drag reduction concepts employ pneumatic concepts to reduce the aerodynamic drag of tractor-trailer truck systems. U.S. Pat. No. 5,908,217 adds a plurality of nozzles to the outer perimeter of the trailer base to control the flow turning from the sides and top of trailer and into the base region. U.S. Pat. No. 6,286,892 adds a porous surface to the trailer base and to the sides and top regions of the trailer abutting the trailer base. These porous surfaces cover a minimum depth plenum that is shared by the sides, top and base regions of the trailer. These two patents provide a drag reduction benefit but as with the other devices discussed previously these devices are complex devices, comprised of moving parts, interfere with normal operations of the truck and add weight to the vehicle. These characteristics of the devices result in a negative impact on the vehicle operational performance.

Representative splash and spray suppression devices are U.S. Pat. Nos. D0,390,521, 01,904,342, 01,904,343, 02,124,513, 02,605,119, and 02,683,612. These patents represent various versions of mud-flaps, wheel guards and other simlar wheel flow splash and spray suppression devices. All of these devices are located directly aft of the wheels and are used specifically for the purpose of suppressing water spray emanating from the wheels and tires. U.S. Pat. Nos. 04,119,331, 04,262,953, 04,386,801, 04,486,046, and 05,921,617 are all devices that deflect the undercarriage flow of a ground vehicle. All of these devices are placed upstream of the most aft set of wheels for a ground vehicle. The purpose of these devices is to minimize the amount of flow passing under the vehicle.

### SUMMARY OF THE INVENTION

The invention is used to reduce the drag and thus, improve the fuel economy of all wheeled ground vehicles including cars, vans, buses, pick-up trucks, delivery trucks, tractor trailer trucks, trains, etc. The invention would add a measure of safety to existing ground transportation environment by eliminating/reducing unsteady separated flow characteristics, aerodynamic induced instabilities, and braking stability. The invention also reduces water splash and spray from tires and wheels, undercarriage and bluff-base wake flows. An additional benefit provided by the invention is the reduced buffeting on nearby vehicles.

The wake flow of a bluff-base ground vehicle produces high drag forces on the parent vehicle, large interference effects on other vehicles in close proximity, water spray and instability in braking and steering. A primary flow mechanism that contributes to the low energy, low momentum, unsteady wake-flow is the undercarriage flow that exits from underneath the trailer and flows into the trailing wake of the vehicle. The unsteady wake flow produces low pressures that act on the bluff-base area and increases the drag of the tractor-trailer and produces unsteadiness and dynamic vehicle motions.

The invention consists of specifically designed aerodynamically contoured surfaces that are positioned under a vehicle. The subject surfaces comprising the invention work in concert with the lower surface of the vehicle and the ground to form a flow nozzle. The minimum opening of the flow nozzle is located at the base of a blunt based ground vehicle and the maximum opening si located upstream of the minimum opening. The surfaces of the subject invention extend forward and outward from the base of the ground vehicle.

The maximum opening of the subject invention is located immediately downstream of the most aft set of wheels of a ground vehicle. The length, thickness, shape, location, and orientation of the surfaces are specifically designed for each ground vehicle: The subject surfaces may be fabricated as an individual unit or as a single unit comprised of multiple panels. The subject surfaces may be manufactured from metal, rubber, plastic, composites, ceramics, etc.

The aerodynamically contoured surfaces that comprise the invention condition the undercarriage flow downstream of the most aft set of wheels by re-energizing the flow and directing the flow into the bluff-base wake thus, increasing the base pressure and lowering base drag. The surfaces comprising the invention generate an accelerated mass of air that is ejected from the minimum opening of the invention and into the bluff-base region of the ground vehicle. The mass, cross sectional area and velocity of this air is determined in the design process by an analysis of the vehicle. The mass, cross sectional area and velocity of the air is based upon the undercarriage flow, the wheel flow, the trailer vehicle height, the vehicle weight, the vehicle length, and the vehicle surface structure. The location, orientation, and geometry of the subject invention are determined by the vehicle geometry, operational requirements, and environment condition. The mass of air ejected into the bluff-base wake conditions the total flow field passing around the vehicle, under the vehicle, and induced by the rotating wheels to create a steady wake structure and increased pressure on the base.

Each surface comprising the invention is shaped in order to take the low momentum undercarriage flow and change it into a coherent high momentum flow. In addition, the resulting momentum addition to the bluff-base wake flow that is provided by the invention influences the flow passing over the top and the sides of the vehicle such that this flow is redirected inwards toward the bluff-base.

The invention collects the low energy, unsteady flow from under the vehicle and from behind the wheels and redirects the flow to the center of the trailer exhausting the re-energized flow into the base region in a direction that is parallel to and opposite the direction of motion of the vehicle. Flow exiting from the invention will be of increased momentum and will energize the wake of the vehicle. The mass addition and energy addition into the wake stabilizes the wake and reduces the turning required by the side and top flows. The pressure in the wake and acting on the bluff-base area is increased and the aerodynamic drag is decreased.

An object of the invention is to use specifically contoured surfaces that are located aft of the most rearward positioned wheels of a vehicle to collect the low energy, unsteady flow that is passing under the vehicle and around the wheels of the vehicle and to condition and direct this flow to the lateral centerline of the vehicle base area where the flow is exhausted rearward and parallel to the direction of motion of the vehicle. The contoured surfaces comprising the invention are specifically shaped and positioned under the vehicle to capture a significant majority of the flow passing under the vehicle and in proximity to the wheels and to condition and accelerate the captured flow to a uniform air jet with increased velocity when it exists the aft facing opening of the invention and enters the bluff-base wake flow of the vehicle. The flow generated by the subject invention is exhausted into the base wake flow where it mixes with the unsteady bluff-base wake flow increasing the wake flow velocity and reducing the wake flow unsteady characteristics. The increase in energy of the bluff-base wake flow resulting from the addition of the high energy undercarriage flow produces a reduction in aerodynamic drag due to an increase in the pressure loading on the bluff-base aft-facing surface of the vehicle or vehicle component, such as the trailer of a tractor-trailer truck. The invention relates to flow in the base region behind a bluff-base vehicle or vehicle component. The flow in the base region behind a bluff-base vehicle or vehicle component is a function of vehicle geometry, vehicle speed and the free stream flow direction.

The device provides improved performance for both the no crosswind condition, in which the air is still, as well as the condition when crosswind flow is present. For all moving vehicles that operate on the ground a crosswind flow is always present due to a combination of atmospheric and environmental factors and the interaction of the naturally occurring wind with stationary geological and manmade structures adjacent to the vehicle path as well as interfering flows from adjacent moving vehicles. The device is designed to reduce aerodynamic drag for the all cross wind conditions for single and multiple-component bluff-base vehicles. The subject device uses specifically designed surfaces to create a flow nozzle concept that accelerates the flow passing under a bluff-base ground vehicle. The increased velocity undercarriage flow is then exhausted into the wake flow of the vehicle where the increased velocity undercarriage mixes with the low velocity wake flow to create a higher velocity wake flow. The subject device provides reduced aerodynamic drag for all bluff-base ground vehicles.

The present invention is a simple device comprised of a minimum number of surfaces that attach to the undercarriage of a ground vehicle or vehicle component. The spacing and orientation of the surfaces, comprising the invention, are dependent upon the vehicle geometry and vehicle operating conditions.

In one embodiment, the invention pioneers a novel device that is comprised of one or more sets of laterally opposing surfaces that replace the most aft set of mud flaps on a ground vehicle. The present invention pioneers a novel device that is comprised of one or more sets of laterally opposing surfaces that may be installed on the undercarriage immediately forward of the bluff-base area of a ground vehicle. The present invention also pioneers a novel device that is comprised of one or more sets of laterally opposing surfaces that can be installed to operate with existing mud flaps on a ground vehicle.

The laterally opposing surfaces comprising the invention in the first embodiment are rigidly attached to the undercarriage or underside of a bluff-base ground vehicle or vehicle component. Each opposing surface extends downward in a vertical direction from the undercarriage or underside of the vehicle towards the surface of the road or ground encompassing a majority of the distance between the vehicle underside and the road. The opposing surfaces are typically positioned on a vehicle between the bluff-base area of a vehicle and the vehicle wheels that are located immediately forward of the bluff-base area of the vehicle. The opposing surfaces are attached to the undercarriage of a vehicle and positioned symmetrically about the vehicle vertical plane of symmetry.

To maximize the ability of each opposing surface to capture the undercarriage flow, the lateral position of the leading edge of each opposing surface is located at the furthest outboard position of the outer facing side edge of the vehicle or vehicle wheels that are located immediately forward of the subject bluff-base area of the vehicle or vehicle component. The lateral separation between the leading edges of opposing surfaces comprising the invention is equivalent to the width of the vehicle. The longitudinal position of the leading edge of each opposing surface is located immediately aft of the vehicle wheels that are located closest to and immediately forward of the subject bluff-base area of the vehicle or vehicle component. The area defined by multiplying the leading edge lateral separation distance by the vertical height of the panels is defined as the capture area of the invention.

To maximize the ability of the subject invention to condition and accelerate the undercarriage flow captured by the subject surfaces, the trailing edge of each surface is located at a lateral position that resides inboard of the inward facing side of the most inboard wheel of the vehicle wheel set that is located closest to and immediately forward of the subject bluff-base area of the vehicle or vehicle component. The lateral separation between the trailing edges of opposing surfaces comprising the invention is less than the lateral spacing between the inward facing surfaces of the laterally opposing wheels located closest to the vehicle centerline of the vehicle. The longitudinal position of the trailing edge of each opposing surface is located at or immediately forward of the bluff-base area of the vehicle or vehicle component. The area defined by multiplying the trailing edge lateral separation distance by the vertical height of the surfaces is defined as the discharge area of the invention. The ability of the subject invention to reduce bluff-base drag of a ground vehicle is a function of the ratio of the capture area to discharge area and the stream-wise contour of the surfaces comprising the invention.

A second embodiment of the invention pioneers a novel device that consists of a specifically designed aerodynamically contoured surface or surfaces that are positioned under a vehicle. The specifically designed aerodynamically contoured surface or surfaces comprising the invention utilize the underside of the vehicle to form a closed conical structure that has its minimum opening located at the base of a bluff-base ground vehicle and its maximum opening located upstream of the minimum opening. The subject invention extends forward and outward from the base of the ground vehicle. The maximum opening of the subject invention is located immediately downstream of the most aft set of wheels of a ground vehicle. The length, thickness, shape, location, and orientation of the surfaces are specifically designed for each ground vehicle. The subject invention may be fabricated as a single surface or as a single unit comprised of multiple surfaces. The subject invention that replaces the most aft set of mud flaps on a ground vehicle. The present invention also pioneers a novel device that can be installed to operate with existing mud flaps on a ground vehicle.

The surface or surfaces comprising the invention in the second embodiment are rigidly attached to the undercarriage or underside of a bluff-base ground vehicle or vehicle component. The surface or surfaces comprising the invention extend downward and forward from the rear of the vehicle such that the subject invention extends a majority of the distance between the vehicle underside and the road at its most forward point. The subject invention is typically positioned on a vehicle between the bluff-base area of a vehicle and the vehicle wheels that are located immediately forward of the bluff-base area of the vehicle. The subject invention is attached to the undercarriage of a vehicle and positioned symmetrically about the vehicle vertical plane of symmetry.

To maximize the ability of invention to capture the undercarriage flow, the lateral separation between the leading edges of the surfaces comprising the invention is equivalent to the width of the vehicle. The longitudinal position of the leading edge of the surfaces is located immediately aft of the vehicle wheels that are located closest to and immediately forward of the subject bluff-base area of the vehicle or vehicle component. The area defined by multiplying the leading edge lateral separation distance by the leading edge vertical height of the surfaces is defined as the capture area of the invention.

To maximize the ability of the subject invention to condition and accelerate the undercarriage flow captured by the subject surfaces, the trailing edge of each surface is located at a lateral position that resides inboard of the inward facing side of the most inboard wheel of the vehicle wheel set that is located closest to and immediately forward of the subject bluff-base area of the vehicle or vehicle component. The lateral separation between the trailing edges of the surfaces comprising the invention is less than the lateral spacing between the inward facing surfaces of the laterally opposing wheels located closest to the vehicle centerline of the vehicle. The longitudinal position of the trailing edge of the surfaces is located at or immediately forward of the bluff-base area of the vehicle or vehicle component. The area defined by multiplying the trailing edge lateral separation distance by the trailing edge vertical height of the surfaces is defined as the discharge area of the invention. The ability of the subject invention to reduce bluff-base drag of a ground vehicle is a function of the ratio of the capture area to discharge area and the stream wise contour of the surfaces comprising the invention.

Each of the surfaces comprising the invention may be fabricated as a single unit or may consist of numerous surfaces that are linked together in a continuous manner.

The reduction of aerodynamic drag, improved operational performance, and improved stability of ground vehicles is obtained by increasing the pressure loading on the bluff base of the vehicle or vehicle component. Increasing the momentum of the undercarriage flow and directing the increased-momentum undercarriage flow into the low energy wake increase the pressure acting on the base area. The high-momentum undercarriage flow is directed into the bluff-base region of the vehicle thereby energizing the wake flow emanating from the bluff base. The high-momentum undercarriage flow has a preferred velocity, direction and mass that will optimize the mixing of the undercarriage flow with the bluff-base wake flow. More specifically, this invention relates to a device and method for reducing aerodynamic drag utilizing a surface or surfaces that are specifically shaped, sized, and orientated to capture and condition the undercarriage flow in order to energizes the bluff-base wake and improve the mixing of the undercarriage flow with the bluff-base wake. The high momentum undercarriage flow energize and stabilize the wake resulting in reduced unsteady flow separation, increased pressures acting on the bluff base area and reduced vehicle aerodynamic drag. The number of surfaces, the orientation and alignment of surfaces, the length of the surfaces, the width of the surfaces and the alignment of the surfaces to the undercarriage flow are the primary design variables that are used to determine the momentum level of the discharge flow and the drag reduction capability of the device. To ensure that a stable coherent discharge flow is formed by the subject invention, each surface is aerodynamically shaped to minimize flow separation.

The invention may be used to reduce the drag of all existing and future ground vehicles (e.g., automobiles, automobiles with trailers, trucks, tractor-trailer trucks, trains, etc.).

### OBJECTS AND ADVANTAGES

Several objects and advantages of the present invention are:
(a) to provide a novel process to reduce the aerodynamic drag of vehicles;
(b) to provide a means to use undercarriage flow to reduce aerodynamic drag;
(c) to provide a means to reduce the aerodynamic drag and improve the operational efficiency of vehicles;
(d) to provide a means to reduce the aerodynamic drag and improve the fuel efficiency of vehicles;
(e) to provide a means to conserve energy and improve the operational efficiency of vehicles;
(f) to provide a means to reduce the aerodynamic drag without a significant geometric modification to existing vehicles;
(g) to provide an aerodynamic drag reduction device that uses one or more aerodynamically shaped surfaces;
(h) to allow the surface contour of each of the surfaces to be variable to meet the specific needs of the application;
(i) to allow the spacing, location, and orientation of each of the surfaces to be variable to meet the specific needs of the application;
(j) to create a high pressure and low aerodynamic drag force on the bluff base of a vehicle;
(k) to allow the device to be fabricated as a number of independent panels that may be applied to an existing vehicle;
(l) to allow the device to be fabricated as a single independent unit that may be applied to an existing vehicle;
(m)to allow the device to be fabricated as an integral part of a vehicle;
(n) to allow for optimal positioning of each of the surfaces on the vehicle lower surface;
(o) to have minimum weight and require minimum volume within the vehicle;
(p) to have minimum maintenance requirements;
(q) to provide a means to reduce the splash and spray of water and/or snow emanating from the wheels, tires, undercarriage and bluff-base wake flow of the vehicle;
(r) to provide a means to reduce the unsteady aerodynamic buffeting loads that adversely affect vehicle in close proximity to the vehicle;
(s) to provide a means to improve the safety of nearby vehicles;

Further objects and advantages are to provide a device that can be easily and conveniently used to minimize aerodynamic drag on any ground vehicle for the purposes of improving the operational performance of the vehicle. Still further objects and advantages will become apparent from a consideration of the ensuing description and drawings.

### BRIEF DESCRIPTION OF THE DRAWINGS

FIG. 1 is a rear perspective view of the aft most portion of a trailer of a tractor-trailer truck system with a typical mud flap installed on the underside of the trailer immediately behind the most aft set of wheels.

FIG. 2 is a rear perspective view of the aft most portion of a trailer of a tractor-trailer truck system with the subject invention installed on the underside of the trailer immediately behind the most aft set of wheels.

FIG. 3 is a rear perspective view of the aft most portion of a trailer of a tractor-trailer truck system with the an alternate embodiment of the subject invention in which the device is installed with a typical mud flap on the underside of the trailer immediately behind the most aft set of wheels.

FIG. 4 is a rear perspective view of the aft most portion of a trailer of a tractor-trailer truck system with an alternate embodiment of the subject invention installed on the underside of the trailer immediately behind the most aft set of wheels.

FIGS. 5a and 5b are lower surface and side views of the aft most portion of a trailer of a tractor-trailer truck system with a typical mud flap installed on the underside of the trailer immediately behind the most aft set of wheels.

FIGS. 6a and 6b are lower surface and side views of the aft most portion of a trailer of a tractor-trailer truck system with the subject invention installed on the underside of the trailer immediately behind the most aft set of wheels.

FIGS. 6c and 6d are lower surface and side views of the aft most portion of a trailer of a tractor-trailer truck system with a linear version of the subject invention installed on the underside of the trailer immediately behind the most aft set of wheels.

FIGS. 7a and 7b are lower surface and side views of the aft most portion of a trailer of a tractor-trailer truck system with the an alternate embodiment of the subject invention in which the device is installed with a typical mud flap on the underside of the trailer immediately behind the most aft set of wheels.

FIGS. 8a and 8b are lower surface and side views of the aft most portion of a trailer of a tractor-trailer truck system with an alternate embodiment of the subject invention installed on the underside of the trailer immediately behind the most aft set of wheels.

FIGS. 9a and 9b are cross section views, in planes horizontal and perpendicular to the ground, of the wake flow conditions for a tractor-trailer system with a typical mud flap system installed.

FIGS. 9c and 9d are cross section views, in planes horizontal to the ground and perpendicular to the ground, of the wake flow conditions for a tractor-trailer system with the subject invention installed

FIGS. 10a to 10d are side and top views of various ground vehicles with and without the subject invention installed.

FIG. 11 is a top, side and rear view of the subject invention fabricated as two continuous side surfaces.

FIG. 12 is a top, side and rear view of the subject invention fabricated as a plurality of independently attached panels comprising two side surfaces.

FIG. 13 is a top, side and rear view of the subject invention fabricated as a plurality of interconnected panels comprising the two side surfaces.

FIG. 14 is a top, side and rear view of the subject invention fabricated as a continuous surface comprised of two sides and a bottom surfaces.

FIG. 15 is a top, side and rear view of the subject invention fabricated as two continuous side surfaces with the outward facing side of each surface containing flow control convolutions.

FIGS. 16a and 16b are side views of alternate embodiments of the subject invention installed on a tractor-trailer truck.

FIGS. 17a to 17d are side views of alternate embodiments of the subject invention installed on various ground vehicles.

### DETAILED DESCRIPTION OF THE INVENTION

The following descriptions are of exemplary embodiments of the invention only, and are not intended to limit the scope, applicability or configuration of the invention in any way. Rather the following description is intended to provide a convenient illustration for implementing various embodiments of the invention. As will become apparent, various changes may be made in the function and arrangement of the elements described herein without departing from the spirit and scope of the invention. For example, though not specifically described, many shapes, widths, leading edge shapes, spacing and orientation of the undercarriage flow control surfaces, candidate vehicles that can benefit from the device, fabrication means and material, attachments means and material should be understood to fall within the scope of the present invention.

Referring now in detail to the drawings, like numerals herein designate like numbered parts in the figures.

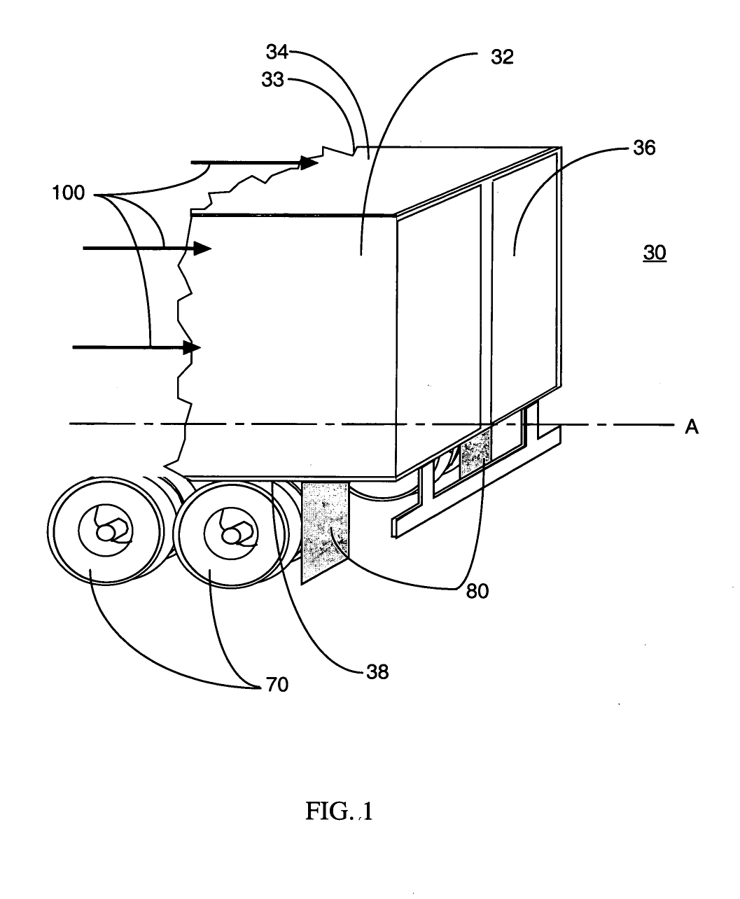

FIG. 1 is a rear perspective view of the aft portion of a typical trailer 30 of a tractor-trailer truck with typical mud flaps 80 installed underneath the trailer and attached to the lower surface 38 of a trailer 30. The shape and size of the mud flaps 80 are a function of the geometry of the trailer undercarriage and the wheels 70. The mud flaps 80 are comprised of pair of downward extending panels that are located immediately behind the most aft set of wheels 70 of the trailer 30.

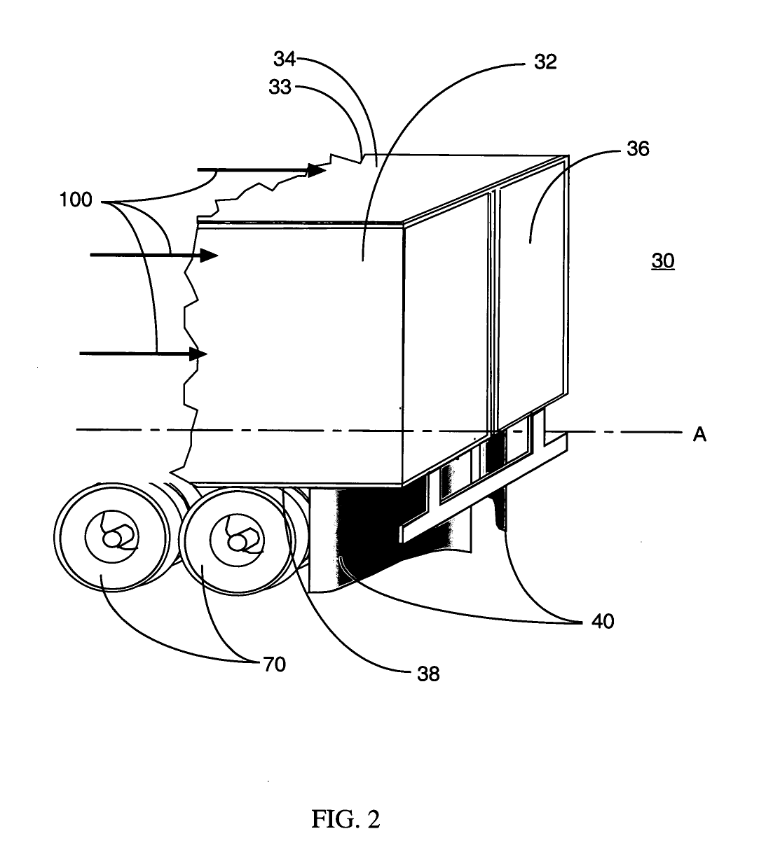

FIG. 2 is a rear perspective view of the aft portion of a typical trailer 30 of a tractor-trailer truck with the subject invention 40 installed underneath the trailer and attached to the lower surface 38 of a trailer 30. The number, shape, size, and orientation of the side surfaces comprising the subject invention 40 are a function of the geometry of the trailer 30, geometry of the trailer top surface lower surface 38 and the geometry of the trailer base surface 36. In one embodiment of the subject invention 40 the side surfaces are comprised of a single pair of opposing side surfaces. These side surfaces are symmetrically oriented on either side of the vehicle centerline A. Each surface is located between the base surface 36 of the trailer 30 and the most aft set of wheels 70.

The pair of opposing surfaces comprising the invention 40 is attached to the lower surface 38 of the vehicle. The side surfaces comprising the invention 40 work in concert with the lower surface 38 of the vehicle and the road that the vehicle is passing over to form a convergent nozzle that directs the undercarriage flow rearward to the base surface 36 of the vehicle 30. The leading edge of each opposing surface 40 are located immediately behind the most aft set of wheels 70 and at a lateral position coincident with the lateral position of the side surfaces 32, 33 of the trailer 30. The trailing edge of the opposing surfaces comprising the invention 40 are located immediately forward of the base surface 36 and at a lateral position that is inboard of the inner wheel of the most aft set of wheels 70. The location of the leading edge and trailing edge of the surfaces comprising the invention 40 is determined by operational and maintenance requirements of the vehicle.

The subject invention 40 provides aerodynamic drag reduction for all free stream flow 100 conditions including crosswind conditions. The subject invention 40 takes advantage of all flow 100 conditions to provide increased aerodynamic drag reduction. Aerodynamic drag reduction occurs when flow 100 that is passing under the vehicle and around the wheels 70 becomes entrained by the surfaces comprising the invention 40. The flow 100 passing under the vehicle is entrained by the invention 40 and directed by the opposing and convergent surfaces 40 inboard and rearward towards the centerline A at the vehicle base surface 36. The convergent surfaces comprising the invention 40 increase the momentum and reduce the unsteady nature of the undercarriage flow. The increased momentum undercarriage flow is discharged from the invention 40 at the vehicle base surface 36 where the undercarriage flow mixes with the wake flow. The high momentum undercarriage flow increases the flow velocity in the wake and reduces the unsteady characteristics of the wake flow. The high momentum undercarriage flow generates a stable bluff-base wake flow and a high pressure that acts on the base surface 36 of the trailer 30. The high momentum undercarriage flow generated by the invention 40 has a preferred velocity and direction in order to increase the mixing of the undercarriage flow with the bluff-base wake flow. The subject invention is comprised of specifically shaped aerodynamic surfaces 40 that are attached to the lower surface 38 of the vehicle and symmetrically positioned about the vertical plane of symmetry of the vehicle.

FIG. 3 is a rear perspective view of the aft portion of a typical trailer 30 of a tractor-trailer truck with an alternate embodiment of the subject invention 40 installed underneath the trailer and attached to the lower surface 38 of a trailer 30. The figure depicts the subject invention discussed in FIG. 2 above installed on a trailer of a tractor-trailer truck with a typical mud flap 80. The number, shape, size, and orientation of the two side surfaces comprising the subject invention 40 are a function of the geometry of the trailer 30, geometry of the trailer top surface lower surface 38 and the geometry of the trailer base surface 36. The subject invention 40 is comprised of a pair of opposing side surfaces that are symmetrically oriented on either side of the vehicle centerline A. Each surface is located between the base 36 of the trailer 30 and the mud flaps 80.

The pair of opposing surfaces comprising the invention 40 is attached to the lower surface 38 of the vehicle. The leading edge of each opposing surface 40 are located immediately behind the mud flaps 80 and at a lateral position coincident with the lateral position of the side surfaces 32, 33 of the trailer 30. The trailing edge of the opposing surfaces comprising the invention 40 are located immediately forward of the base area 36 and at a lateral position that is inboard of the inner wheel of the most aft set of wheels 70. The location of the leading edge and trailing edge of the surfaces comprising the invention 40 is determined by operational and maintenance requirements of the vehicle.

The subject invention 40 provides aerodynamic drag reduction for all free stream flow 100 conditions including crosswind conditions. The subject invention 40 takes advantage of all flow 100 conditions to provide increased aerodynamic drag reduction. Aerodynamic drag reduction occurs when flow 100 that is passing under the vehicle and around the wheels 70 becomes entrained by the surfaces comprising the invention 40. The flow 100 passing under the vehicle is entrained by the invention 40 and directed by the opposing and convergent surfaces 40 inboard and rearward towards the centerline A at the vehicle base 36. The convergent surfaces comprising the invention 40 increase the momentum and reduce the unsteady nature of the undercarriage flow. The increased momentum undercarriage flow is discharged from the invention 40 at the vehicle base 36 where the undercarriage flow mixes with the wake flow. The high momentum undercarriage flow increases the flow velocity in the wake and reduces the unsteady characteristics of the wake flow. The high momentum undercarriage flow generates a stable bluff-base wake flow and a high pressure that acts on the base surface 36 of the trailer 30. The high momentum undercarriage flow generated by the invention 40 has a preferred velocity and direction in order to increase the mixing of the undercarriage flow with the bluff-base wake flow. The subject invention is comprised of specifically shaped aerodynamic surfaces 40 that are attached to the lower surface 38 of the vehicle and symmetrically positioned about the vertical plane of symmetry of the vehicle.

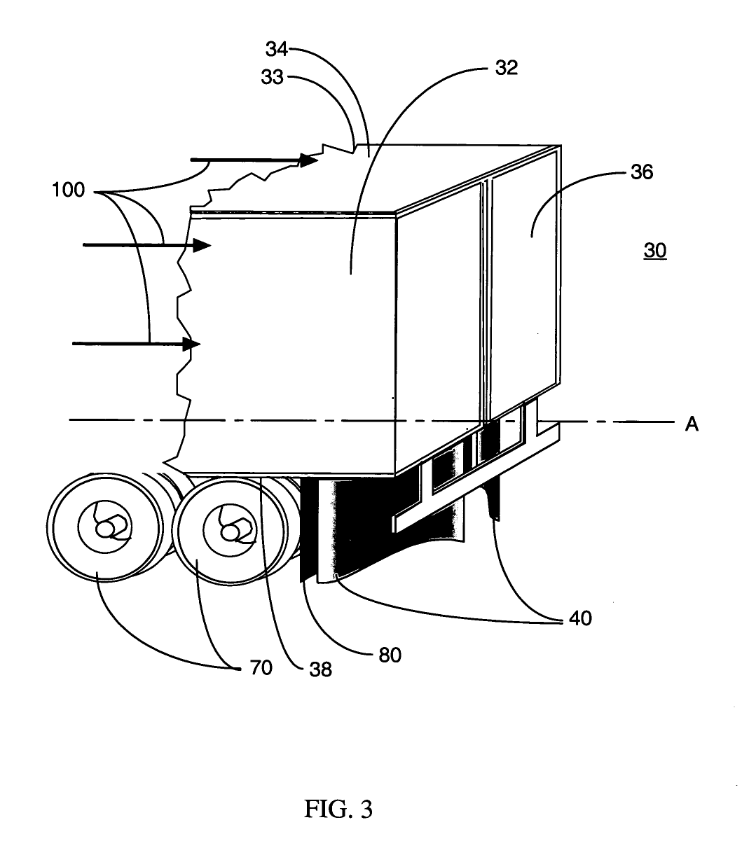

FIG. 4 is a rear perspective view of the aft portion of a typical trailer 30 of a tractor-trailer truck with an alternate embodiment of the subject invention 40 installed underneath the trailer and attached to the lower surface 38 of a trailer 30. The number, shape, size, and orientation of the two side surfaces and lower surface comprising the subject invention 40 are a function of the geometry of the trailer 30, geometry of the trailer lower surface 38 and the geometry of the trailer base surface 36. The subject invention 40 is comprised of a pair of opposing side surfaces and a lower surface. The two side surfaces are symmetrically oriented on either side of the vehicle centerline A. The lower surface is attached to bottom edge of the two side surfaces. These three surfaces comprising the invention 40 work with the lower surface 38 of the vehicle 30 to form a convergent flow nozzle that directs the undercarriage flow to the base 36 of the vehicle 30. The subject invention is located between the base 36 of the trailer 30 and the most aft set of wheels 70.

The pair of opposing side surfaces of the invention 40 is attached to the lower surface 38 of the vehicle. The leading edge of each surface 40 is located immediately behind the most aft set of wheels 70. The maximum lateral position of the leading edge of the surfaces 40 is coincident with the lateral position of the side surfaces 32, 33 of the trailer 30. The trailing edge of the surfaces comprising the invention 40 are located immediately forward of the base area 36 and the maximum lateral position resides inboard of the inner wheel of the most aft set of wheels 70. The location of the leading edge and trailing edge of the surfaces comprising the invention 40 is determined by operational and maintenance requirements of the vehicle.

The subject invention 40 provides aerodynamic drag reduction for all free stream flow 100 conditions including crosswind conditions. The subject invention 40 takes advantage of all flow 100 conditions to provide increased aerodynamic drag reduction. Aerodynamic drag reduction occurs when flow 100 that is passing under the vehicle and around the wheels 70 becomes entrained by the surfaces comprising the invention 40. The flow 100 passing under the vehicle is entrained by the invention 40 and directed by the opposing and convergent surfaces 40 inboard and rearward towards the centerline A at the vehicle base 36. The convergent surfaces comprising the invention 40 increase the momentum and reduce the unsteady nature of the undercarriage flow. The increased momentum undercarriage flow is discharged from the invention 40 at the vehicle base 36 where the undercarriage flow mixes with the wake flow. The high momentum undercarriage flow increases the flow velocity in the wake and reduces the unsteady characteristics of the wake flow. The high momentum undercarriage flow generates a stable bluff-base wake flow and a high pressure that acts on the base surface 36 of the trailer 30. The high momentum undercarriage flow generated by the invention 40 has a preferred velocity and direction in order to increase the mixing of the undercarriage flow with the bluff-base wake flow. The subject invention is comprised of specifically shaped aerodynamic surfaces 40 that are attached to the lower surface 38 of the vehicle and symmetrically positioned about the vertical plane of symmetry of the vehicle.

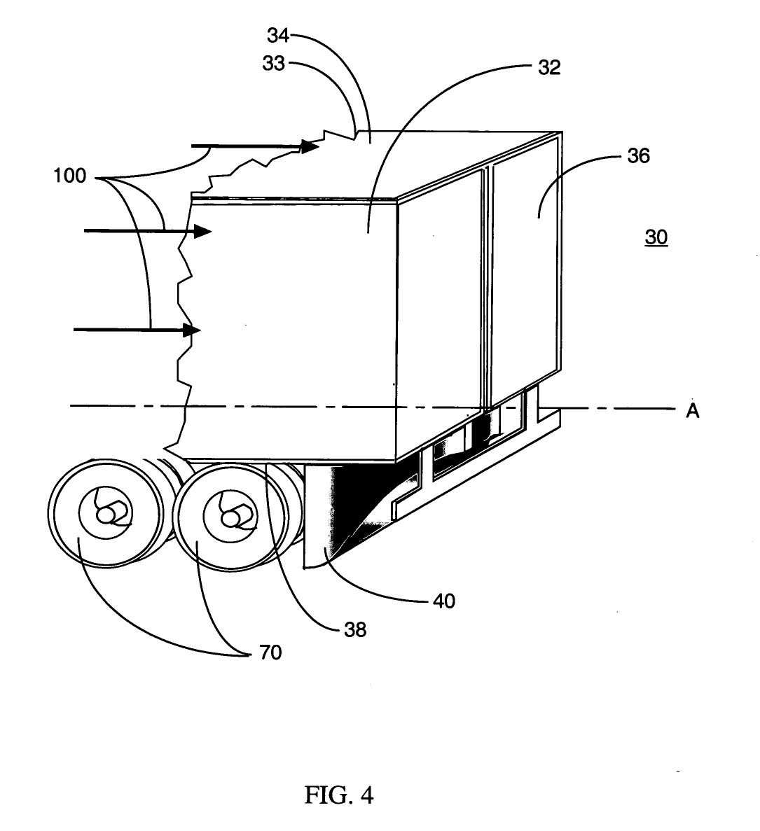

FIGS. 5a and 5b are lower surface 38 and side views of the aft most portion of a trailer 30 of a tractor-trailer truck with a typical mud flap 80 installed on the underside of the trailer immediately behind the most aft set of wheels 70. The shape and size of the mud flaps 80 are a function of the geometry of the trailer undercarriage and the tires 70. The mud flaps 80 extend laterally from the trailer outward facing side surface 32, 33 inward to a position inboard of the wheel set 70. The mud flaps 80 extend vertically from the trailer lower surface 38 downward to a position just above the road.

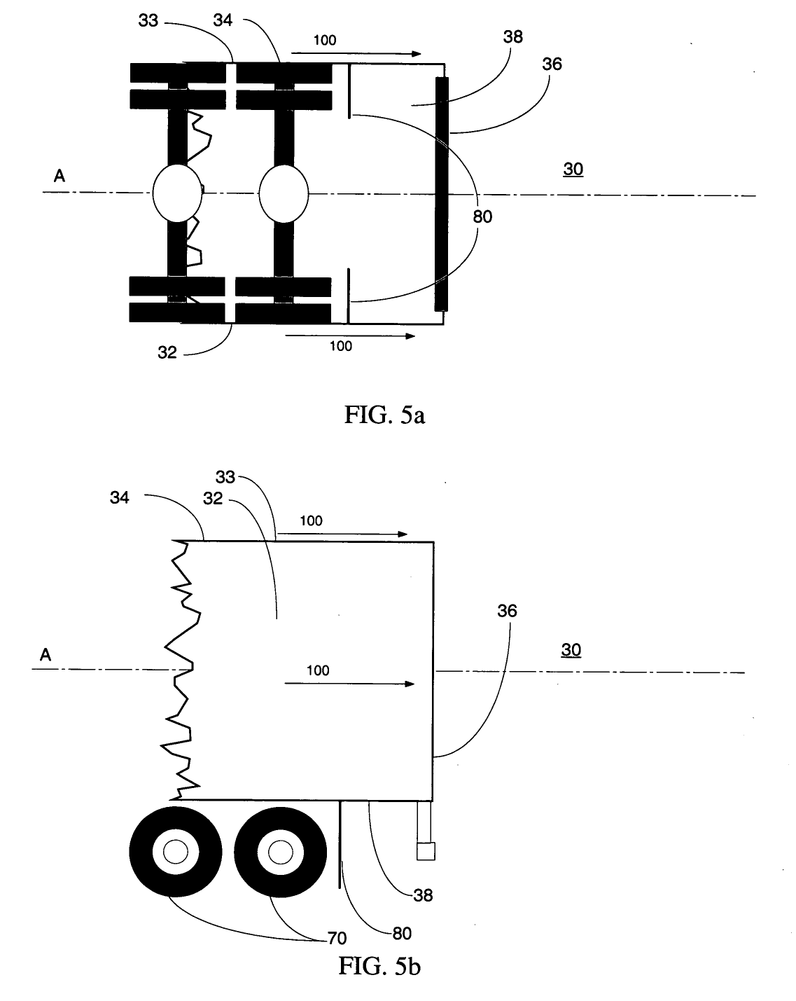

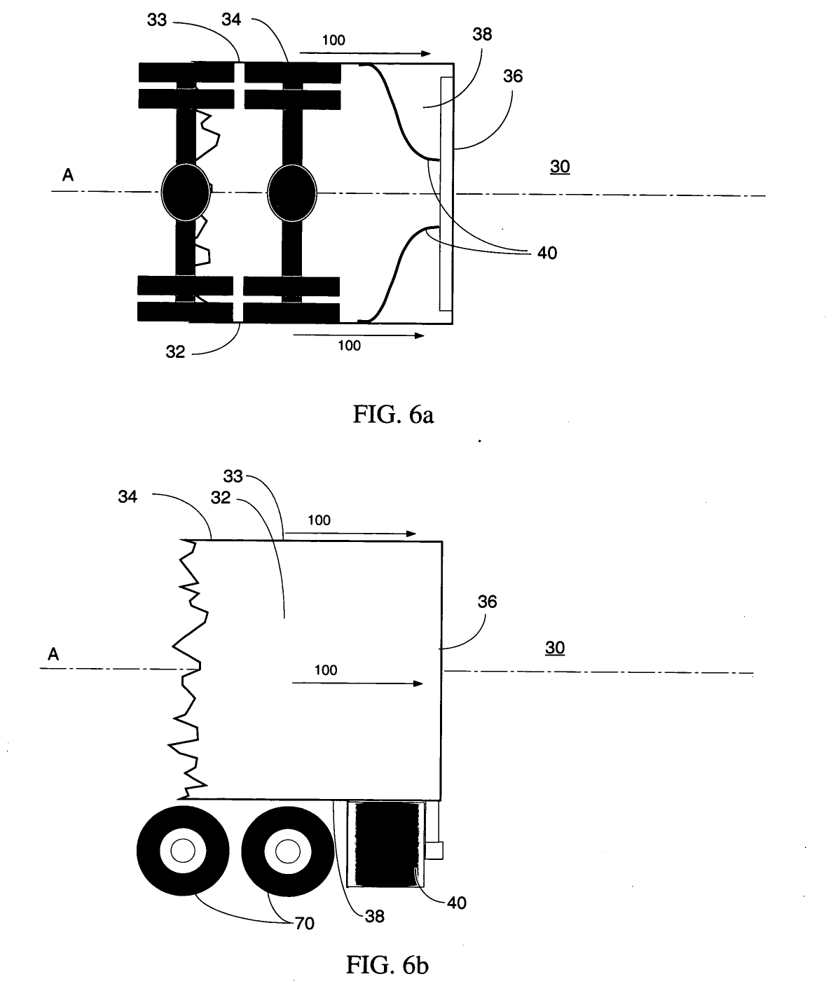

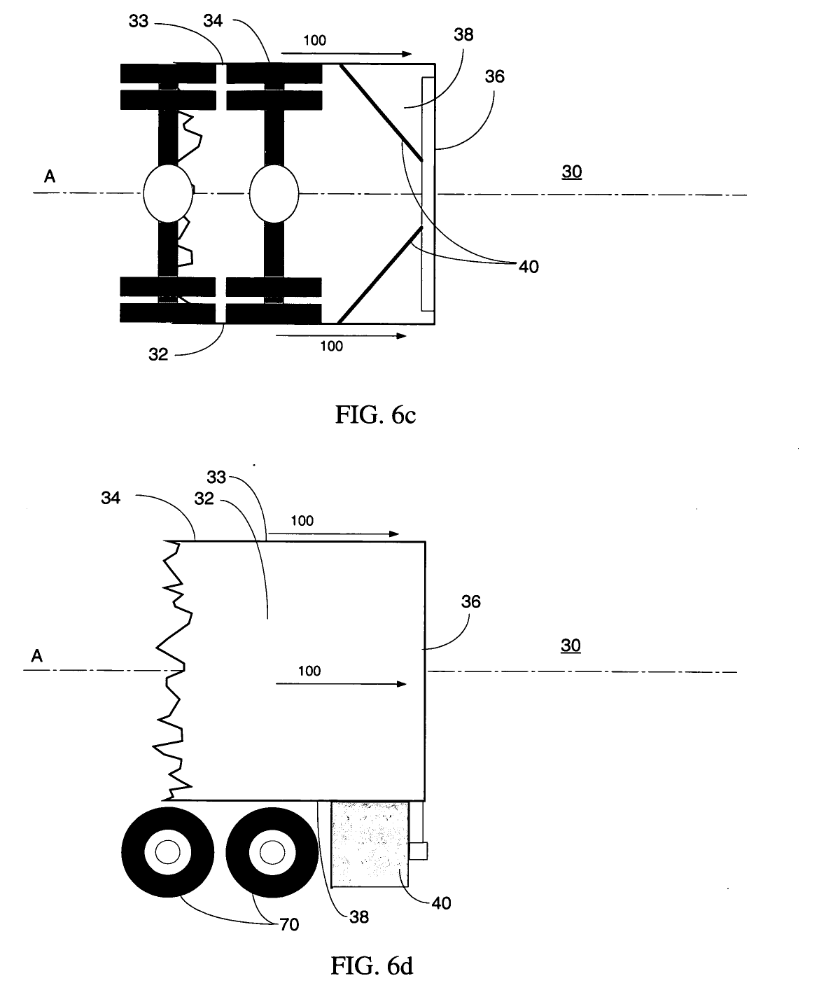

FIGS. 6a and 6b are lower surface and side views of the aft most portion of a trailer 30 of a tractor-trailer truck system with the subject invention 40 installed on the underside 38 of the trailer 30 immediately behind the most aft set of wheels 70. The number, shape, size, and orientation of the two side surfaces comprising the subject invention 40 are a function of the geometry of the trailer 30, geometry of the trailer top surface lower surface 38 and the geometry of the trailer base surface 36. The subject invention 40 is comprised of a pair of opposing side surfaces that are symmetrically oriented on either side of the vehicle centerline A. Each surface is located between the base 36 of the trailer 30 and the most aft set of wheels 70.

The pair of opposing surfaces comprising the invention 40 is attached to the lower surface 38 of the vehicle. The leading edge of each opposing surface 40 are located immediately behind the most aft set of wheels 70 and at a lateral position coincident with the lateral position of the side surfaces 32, 33 of the trailer 30. The trailing edge of the opposing surfaces comprising the invention 40 are located immediately forward of the base area 36 and at a lateral position that is inboard of the inner wheel of the most aft set of wheels 70. The location of the leading edge and trailing edge of the surfaces comprising the invention 40 is determined by operational and maintenance requirements of the vehicle.

FIGS. 6c and 6d are lower surface and side views of the aft most portion of a trailer 30 of a tractor-trailer truck system with an alternate embodiment of the subject invention 40 installed on the underside 38 of the trailer 30 immediately behind the most aft set of wheels 70. The two side surfaces comprising the subject invention 40 vary linearly in the streamwise direction. The subject invention 40 is comprised of a pair of opposing side surfaces that are symmetrically oriented on either side of the vehicle centerline A. Each surface is located between the base 36 of the trailer 30 and the most aft set of wheels 70.

The pair of opposing surfaces comprising the invention 40 is attached to the lower surface 38 of the vehicle. The leading edge of each opposing surface 40 are located immediately behind the most aft set of wheels 70 and at a lateral position coincident with the lateral position of the side surfaces 32, 33 of the trailer 30. The trailing edge of the opposing surfaces comprising the invention 40 are located immediately forward of the base area 36 and at a lateral position that is inboard of the inner wheel of the most aft set of wheels 70. The location of the leading edge and trailing edge of the surfaces comprising the invention 40 is determined by operational and maintenance requirements of the vehicle.

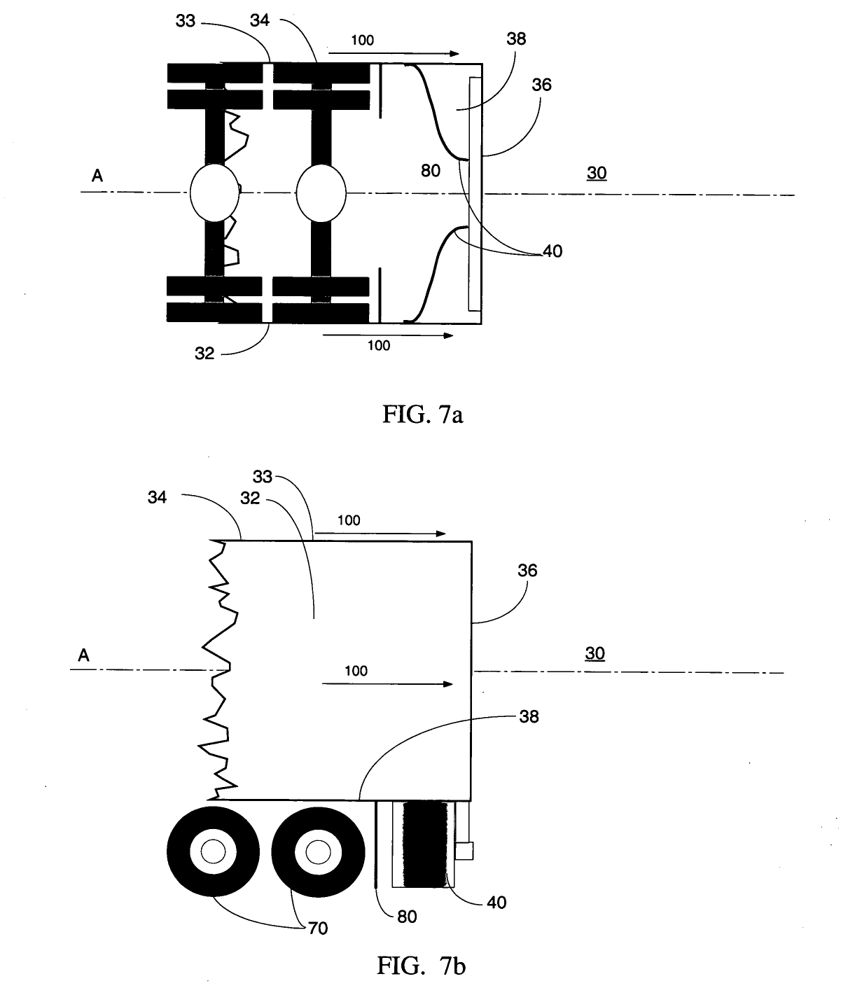

FIGS. 7a and 7b are lower surface and side views of the aft most portion of a trailer 30 of a tractor-trailer truck system with the an alternate embodiment of the subject invention in which the device 40 is installed with a typical mud flap 80 on the underside 38 of the trailer 30 immediately behind the most aft set of wheels 70. The number, shape, size, and orientation of the two side surfaces comprising the subject invention 40 are a function of the geometry of the trailer 30, geometry of the trailer top surface lower surface 38 and the geometry of the trailer base surface 36. The subject invention 40 is comprised of a pair of opposing side surfaces that are symmetrically oriented on either side of the vehicle centerline A. Each surface is located between the base 36 of the trailer 30 and the mud flaps 80.

The pair of opposing surfaces comprising the invention 40 is attached to the lower surface 38 of the vehicle. The leading edge of each opposing surface 40 are located immediately behind the mud flaps 80 and at a lateral position coincident with the lateral position of the side surfaces 32, 33 of the trailer 30. The trailing edge of the opposing surfaces comprising the invention 40 are located immediately forward of the base area 36 and at a lateral position that is inboard of the inner wheel of the most aft set of wheels 70. The location of the leading edge and trailing edge of the surfaces comprising the invention 40 is determined by operational and maintenance requirements of the vehicle.

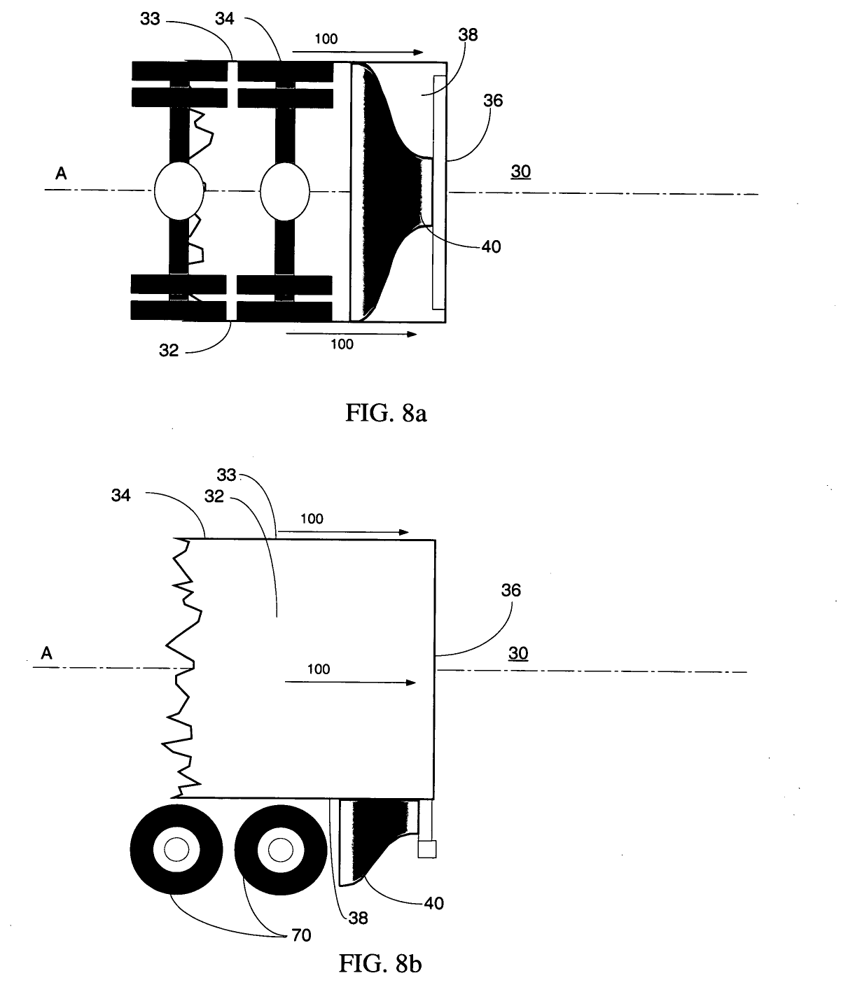

FIGS. 8a and 8b are lower surface and side views of the aft most portion of a trailer 30 of a tractor-trailer truck system with an alternate embodiment of the subject invention 40 installed on the underside 38 of the trailer 30 immediately behind the most aft set of wheels 70. The number, shape, size, and orientation of the two side and lower surfaces comprising the subject invention 40 are a function of the geometry of the trailer 30, geometry of the trailer top surface lower surface 38 and the geometry of the trailer base surface 36. The subject invention 40 is comprised of a pair of opposing side surfaces and a lower surface. The two side surfaces are symmetrically oriented on either side of the vehicle centerline A. The lower surface is attached to bottom edge of the two side surfaces to form a three dimensional conical structure with the lower surface of the vehicle 30. The subject invention is located between the base 36 of the trailer 30 and the most aft set of wheels 70.

The pair of opposing side surfaces of the invention 40 is attached to the lower surface 38 of the vehicle. The leading edge of each surface 40 is located immediately behind the most aft set of wheels 70. The maximum lateral position of the leading edge of the surfaces 40 is coincident with the lateral position of the side surfaces 32, 33 of the trailer 30. The trailing edge of the surfaces comprising the invention 40 are located immediately forward of the base area 36 and the maximum lateral position resides inboard of the inner wheel of the most aft set of wheels 70. The location of the leading edge and trailing edge of the surfaces comprising the invention 40 is determined by operational and maintenance requirements of the vehicle.

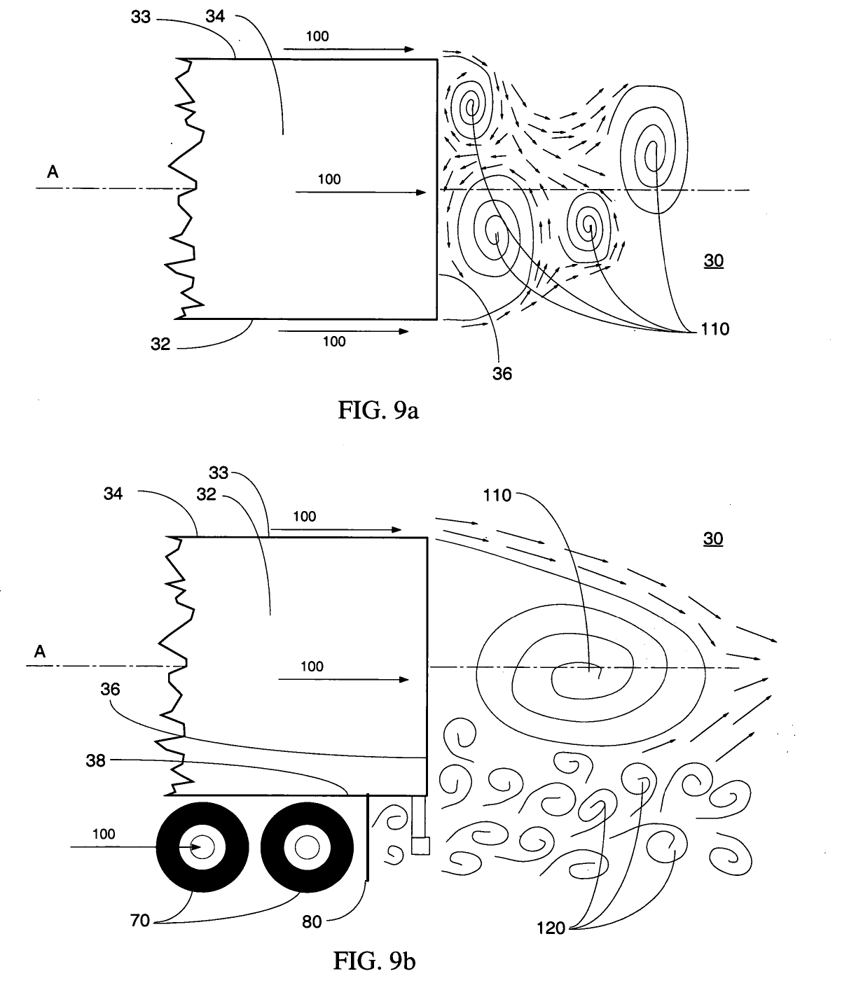

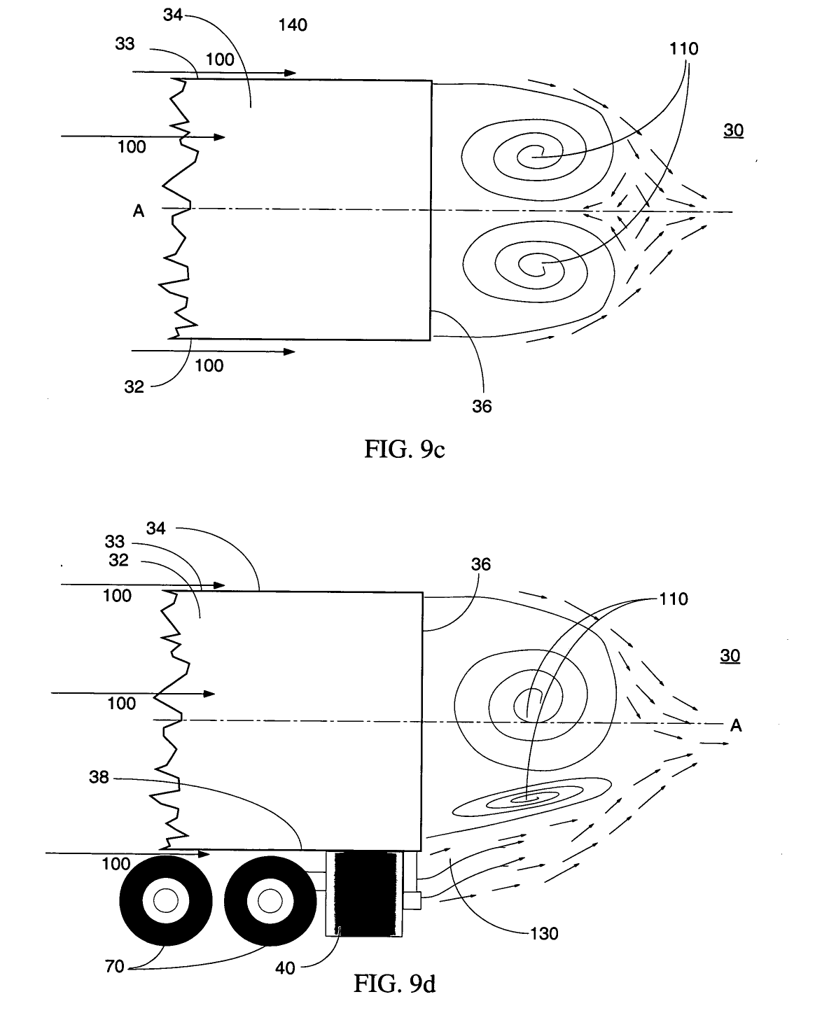

FIG. 9a through FIG. 9d show flow patterns in the wake of a bluff-base tractor-trailer truck with and without the present invention 40 installed. In FIG. 9a through FIG. 9d the airflow about the vehicle and in the base region is represented by arrow tipped lines and swirl structures 100, 110, 120 and 130. The shaded swirl structures represent rotational wake flow 110. The small swirl structures represent turbulent flow structures 120 in the base area and from the vehicle undercarriage. The long arrow tipped lines emanating from the under the vehicle at the base represent high momentum undercarriage flow 130.

FIG. 9a show a cross section view, in a plane horizontal to the ground, of the aft portion of a trailer 30 and the bluff-base wake flow, without the subject invention installed. For this condition, a surface flow 100 develops on the trailer that separates at the trailing edge of the side surfaces 32 and 33, and forms rotational-flow structures 110 that comprise the bluff-base wake flow. The rotational-flow structures 110 are shed asymmetrically from the opposing side surfaces 32 and 33. These rotational-flow structures 110 continue to move downstream in a random pattern. The asymmetric shedding of the rotational-flow structures 110 produce low pressures that act on the base surface 36 of the trailer. These low pressures result in a high aerodynamic drag force. The low energy flow 100 separating at the trailing edges of the side surfaces 32 and 33 of the trailer 30 is unable to energize and stabilize the low energy bluff-base wake flow. The resulting bluff-base wake-flow structure emanating from the base area of the vehicle is comprised of the vortex structures 110 that are shed from trailing edges of the side surfaces 32 and 33 of the trailer 30. Contributing to the low-energy bluff-base wake is the low-energy turbulent flow 120 that exits from the vehicle undercarriage at the base of the vehicle.

FIG. 9b show a centerline cross section view of the aft portion of a trailer 30 and the bluff-base wake flow, without the subject invention installed. This schematic is for a single period in time. For this condition, a surface flow 100 develops on the trailer that separates at the trailing edge of the top surface 34 and forms a rotational-flow structure 110 that comprises the bluff-base wake flow. The rotational-flow structure 110 that is shed from the trailing edge of the top surface 34 is asymmetrically positioned in the wake. As a function of time this rotational-flow structure 110 will move downstream in a random pattern and be replaced by a duplicate rotational-flow structure 110. The unsteady shedding of the rotational-flow structure 110 produces low pressures that act on the base surface 36 of the trailer 30. These low pressures result in a high aerodynamic drag force. The low energy flow 100 separating at the trailing edges of the top surface 34 of the trailer 30 is unable to energize and stabilize the low energy bluff-base wake flow. Contributing to the low-energy bluff-base wake is the low-energy turbulent flow 120 that exits from the vehicle undercarriage at the trailing edge of the vehicle. The resulting bluff-base wake-flow structure emanating from the base area of the vehicle is comprised of the vortex structures 110 that are shed from trailing edges of the side surfaces 32 and 33 and the top surface 34 of the vehicle. The low-energy turbulent flow 120 that exists from the vehicle undercarriage also enters into the bluff-base wake flow. The unsteady wake flow imparts a low pressure onto the aft facing surface 36 of the trailer base that results in significant aerodynamic drag.

FIG. 9c and FIG. 9d show a top view and a side view of the aft portion of a trailer 30 and cross section views in a plane horizontal to the ground and along the vehicle centerline of the bluff-base wake flow, with the subject invention 40 installed. For this condition, the flow 100 passing under the vehicle is entrained by the device 40 and is discharged at the base of the vehicle with increased momentum 130. The surfaces comprising the subject invention 40 are symmetrically positioned about the vehicle centerline under the trailer 30. Each surface of the subject invention 40 is specifically shaped to maximize the entrainment of the undercarriage flow and the discharge momentum of this flow at the base of the vehicle 30. The high-momentum undercarriage-flow 130 is directed downstream, in a symmetric pattern, and exits the invention 40 at the base of the vehicle 30. This high-momentum undercarriage-flow 130 produces a rotational-flow structure 110 that is rotating in the opposite direction to the rotational-flow structure 110 emanating from the trailing edge of the top surface 34. The high momentum flow 130 energizes the bluff-base wake flow. The high-momentum undercarriage-flow 130 generates a stable bluff-base wake flow and a high pressure that acts on the base surface 36 of the trailer 30. The strength of the high-momentum undercarriage-flow 130 formed by the device 40 and thus the aerodynamic drag reduction benefit will increase with increasing velocity of the flow 100. The high-momentum undercarriage-flow 130 generated by the invention 40 has a preferred velocity and direction in order to increase the mixing of the undercarriage flow with the bluff-base wake flow.

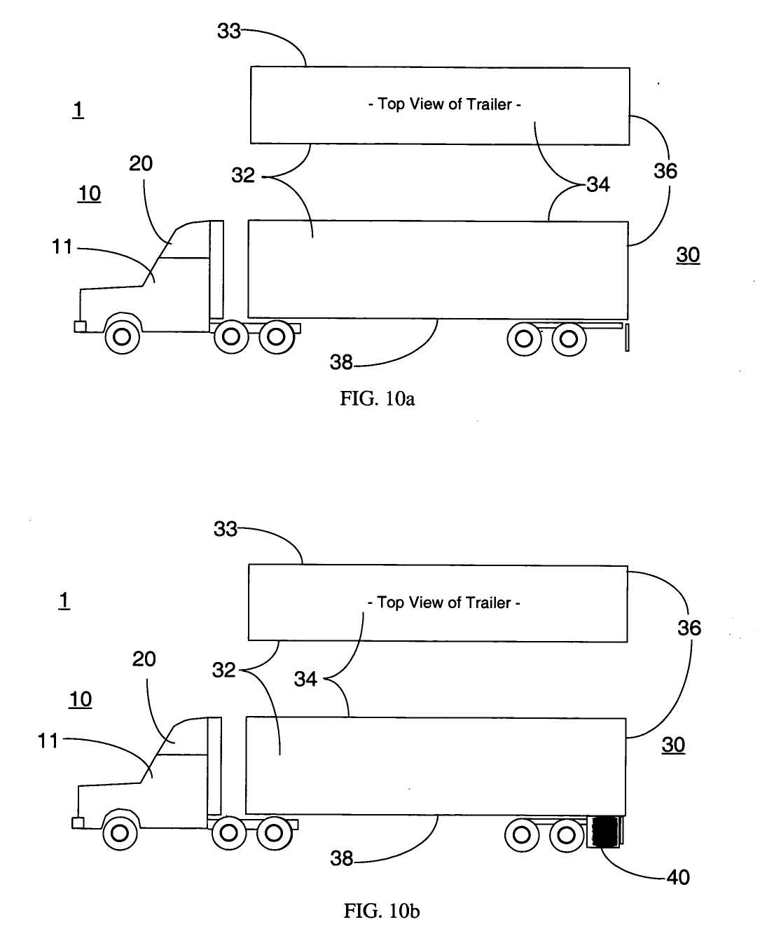

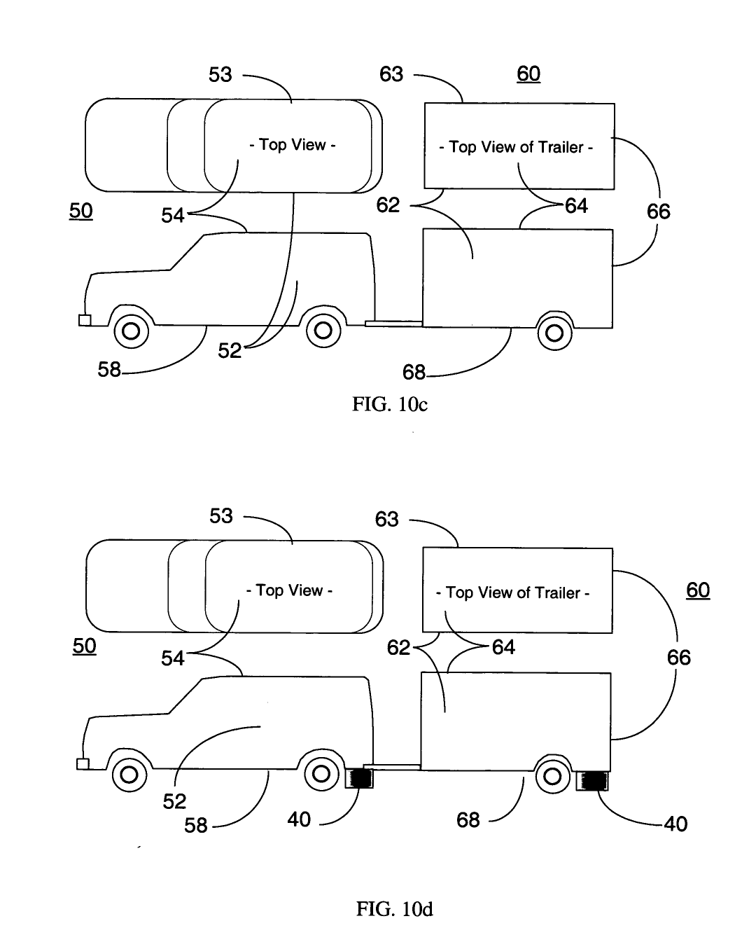

FIG. 10a through FIG. 10d are side and top views of example ground vehicles with and without the subject invention installed. FIG. 10a shows a typical tractor-trailer truck system 1, comprised of a powered tractor 10 that pulls a trailer 30. The tractor 10 is comprised of a cab 11 and an aerodynamic fairing system 20 that may be an integral part of the tractor 10. FIG. 10b shows the same tractor-trailer truck system 1 as that of FIG. 3a with the subject invention 40 installed on the lower surface 38 of the trailer 30. The surfaces that comprise the invention 40 are symmetrically about the vehicle centerline. FIG. 10c and FIG. 10d show an automobile 50 pulling a trailer 60 with and without the subject invention 40 installed on both the automobile and trailer lower surface 58 and 68, respectively. The surfaces that comprise the invention 40 are symmetrically about the vehicle centerline. The various vehicles depicted in FIG. 10 shows a powered vehicle towing/pulling an un-powered towed vehicle. Additionally, other multiple component vehicles may be considered than those depicted.

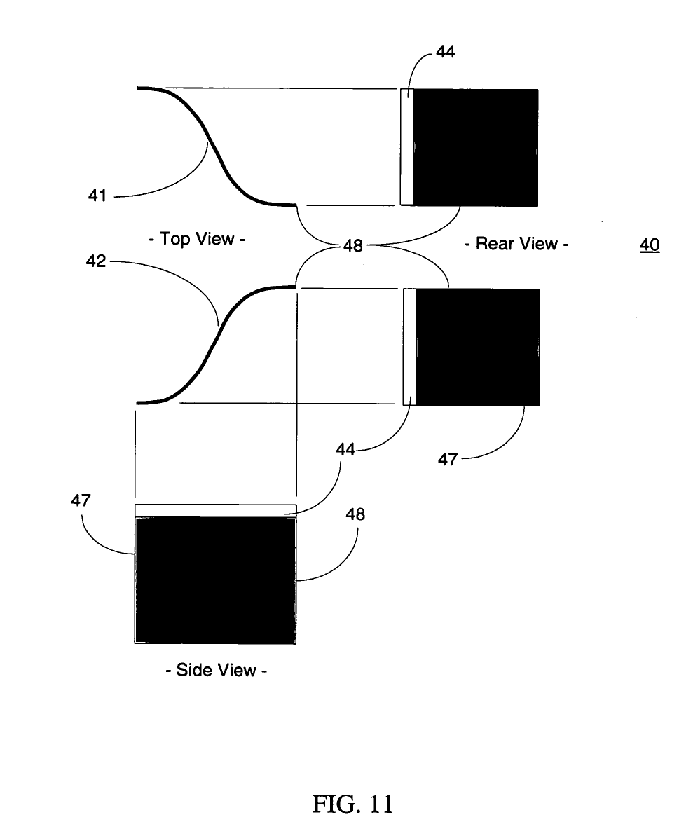

FIG. 11 is a top, side and rear view of the subject invention 40 fabricated as two continuous side surfaces 41 and 42. The side surfaces 41 and 42 are aerodynamically shaped to minimize flow separation on the inward facing and outward facing surfaces. The surfaces 41 and 42 comprising the invention are mirror images of each other and are characterized as having a constant height. The invention 40 has a leading edge 47 and a trailing edge 48. The lateral and longitudinal separation of the leading edge 47 and trailing edge 48 for the two surfaces 41 and 42 are a primary design variable. The side surfaces are attached to a mounting bracket 44. Example material for the side surfaces 41 and 42 may be any light-weight and structurally sound rubber, metal, plastic, composite or other suitable material. The means that the surfaces 41 and 42 are attached to the bracket 44 may be bonding, welding, mechanical or other appropriate structural attachments. The subject invention 40 is attached to the lower surface 38 of a vehicle by a means 45. The attachments means 45 may consist of mechanical fasteners or other appropriate means.

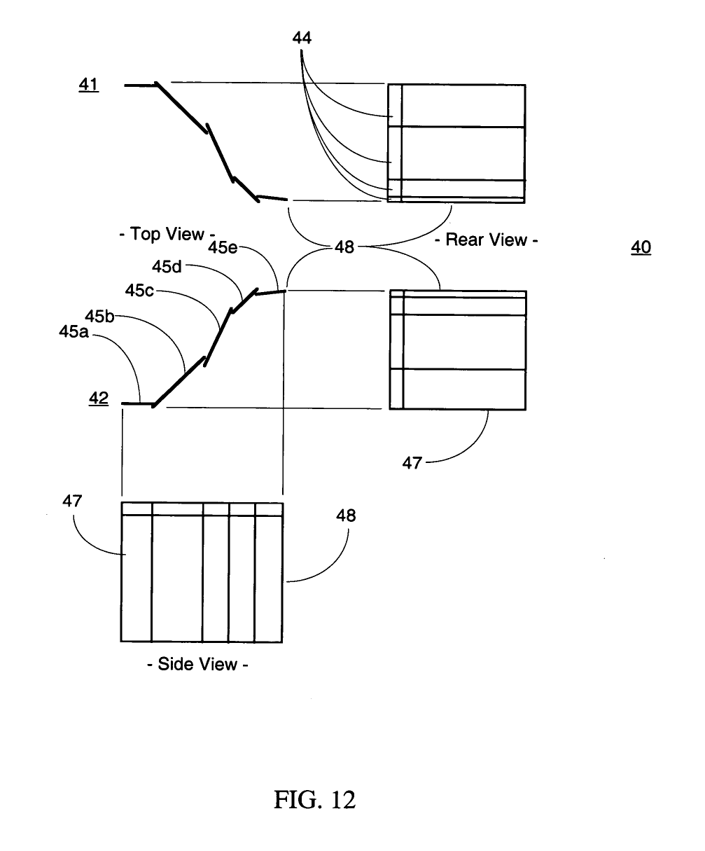

FIG. 12 is a top, side and rear view of the subject invention 40 fabricated as a plurality of independent panels 45a-45e that comprise two side surfaces 41 and 42. The plurality of independent panels 45a-45e that comprise the side surfaces 41 and 42 are orientated to simulate the desired aerodynamic shape required to minimize flow separation on the inward facing and outward facing surfaces. The surfaces 41 and 42 comprising the invention are mirror images of each other and are characterized as having a constant height. The invention 40 has a leading edge 47 and a trailing edge 48. The lateral and longitudinal separation of the leading edge 47 and trailing edge 48 for the two surfaces 41 and 42 are a primary design variable. Each of the side panels comprising the side surfaces are attached to individual mounting brackets 44. Example material for the side surfaces 41 and 42 may be any light-weight and structurally sound rubber, metal, plastic, composite or other suitable material. The means that the surfaces 41 and 42 are attached to the bracket 44 may be bonding, welding, mechanical or other appropriate structural attachments. The subject invention 40 is attached to the lower surface 38 of a vehicle by a means 45. The attachments means 45 may consist of mechanical fasteners or other appropriate means.

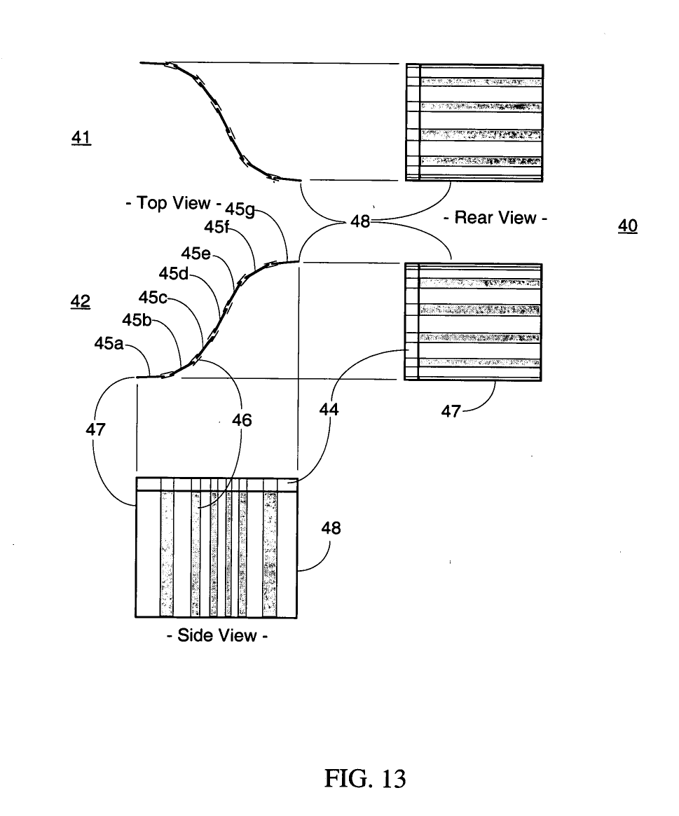

FIG. 13 is a top, side and rear view of the subject invention 40 fabricated as a plurality of interconnected panels 45a-45g comprising the two side surfaces 41 and 42. The plurality of interconnected panels 45a-45g that comprise the side surfaces 41 and 42 are mechanically linked with a mechanical seal 46. The plurality of interconnected panels 45a-45g that comprise the side surfaces 41 and 42 are orientated to simulate the desired aerodynamic shape required to minimize flow separation on the inward facing and outward facing surfaces. The surfaces 41 and 42 comprising the invention are mirror images of each other and are characterized as having a constant height. The invention 40 has a leading edge 47 and a trailing edge 48. The lateral and longitudinal separation of the leading edge 47 and trailing edge 48 for the two surfaces 41 and 42 are a primary design variable. Each of the side panels comprising the side surfaces are attached to individual mounting brackets 44. Example material for the side surfaces 41 and 42 may be any light-weight and structurally sound rubber, metal, plastic, composite or other suitable material. The means that the surfaces 41 and 42 are attached to the bracket 44 may be bonding, welding, mechanical or other appropriate structural attachments. The subject invention 40 is attached to the lower surface 38 of a vehicle by a means 45. The attachments means 45 may consist of mechanical fasteners or other appropriate means.

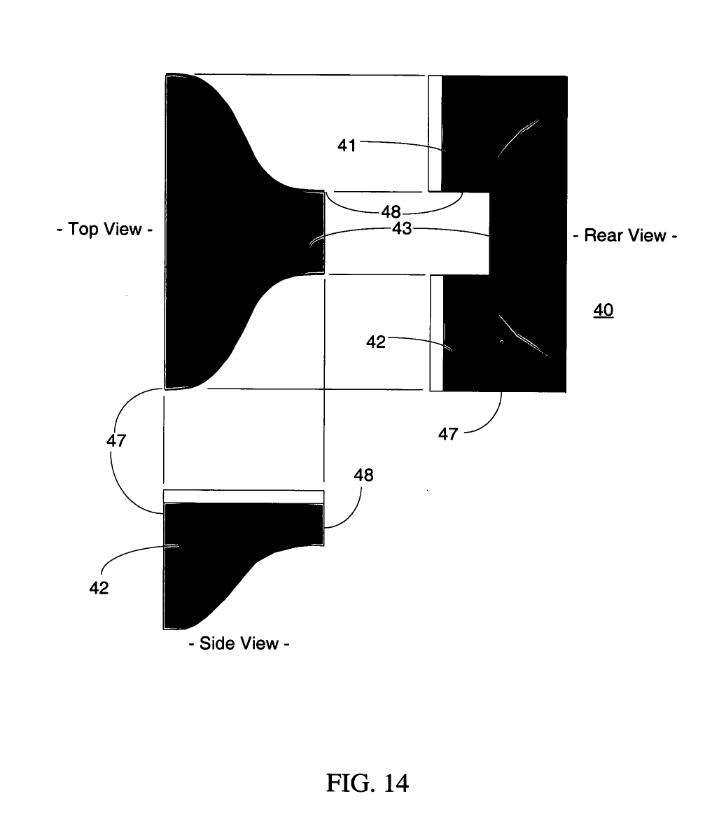

FIG. 14 is a top, side and rear view of the subject invention 40 fabricated as a continuous surface comprised of two side surfaces 41 and 42 and a bottom surface 43. The surfaces 41, 42 and 43 are aerodynamically shaped to minimize flow separation on the inward facing and outward facing surfaces. The side surfaces 41 and 42 comprising the invention are mirror images of each other. The invention 40 has a leading edge 47 and a trailing edge 48. The lateral and longitudinal separation of the leading edge 47 and trailing edge 48 for the two surfaces 41, 42 and 43 are a primary design variable. The side surfaces are attached to a mounting bracket 44. The bottom surface 43 attaches to the two side surfaces 41 and 42. Example material for the surfaces 41, 42 and 43 may be any light-weight and structurally sound rubber, metal, plastic, composite or other suitable material. The means that the surfaces 41 and 42 are attached to the bracket 44 may be bonding, welding, mechanical or other appropriate structural attachments. The subject invention 40 is attached to the lower surface 38 of a vehicle by a means 45. The attachments means 45 may consist of mechanical fasteners or other appropriate means.

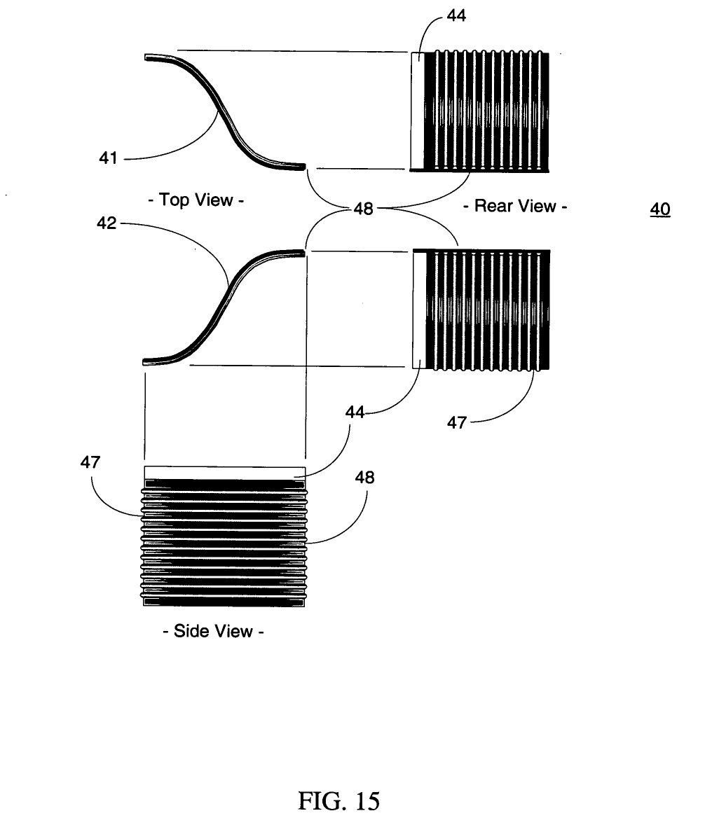

FIG. 15 is a top, side and rear view of an alternate embodiment of the subject invention 40 fabricated as two continuous side surfaces 41 and 42 with the outward facing side of each surface containing flow control convolutions. The inward facing area of each side surfaces 41 and 42 is smooth and aerodynamically shaped to minimize flow separation. The outward facing side of each side surfaces 41 and 42 is modified with convolutions to minimize flow separation. The surfaces 41 and 42 comprising the invention are mirror images of each other and are characterized as having a constant height. The invention 40 has a leading edge 47 and a trailing edge 48. The lateral and longitudinal separation of the leading edge 47 and trailing edge 48 for the two surfaces 41 and 42 are a primary design variable. The side surfaces are attached to a mounting bracket 44. Example material for the side surfaces 41 and 42 may be any light-weight and structurally sound rubber, metal, plastic, composite or other suitable material. The means that the surfaces 41 and 42 are attached to the bracket 44 may be bonding, welding, mechanical or other appropriate structural attachments. The subject invention 40 is attached to the lower surface 38 of a vehicle by a means 45. The attachments means 45 may consist of mechanical fasteners or other appropriate means.

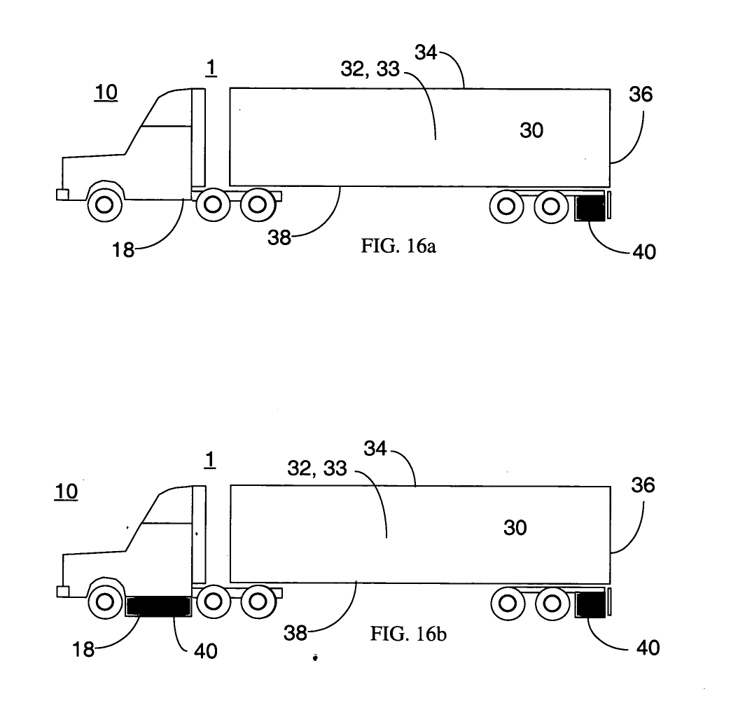

FIGS. 16a and 16b are side views of various embodiments of the subject invention 40 installed on a tractor-trailer truck 1. FIG. 16a is a side view of a tractor-trailer truck 1 with the subject invention 40 installed in the furthest aft position on the trailer 30 lower surface 38. FIG. 7b is a side view of a tractor-trailer truck 1 with the subject invention 40 installed on the lower surface 18 of the tractor 10 and the lower surface 38 of a trailer 30

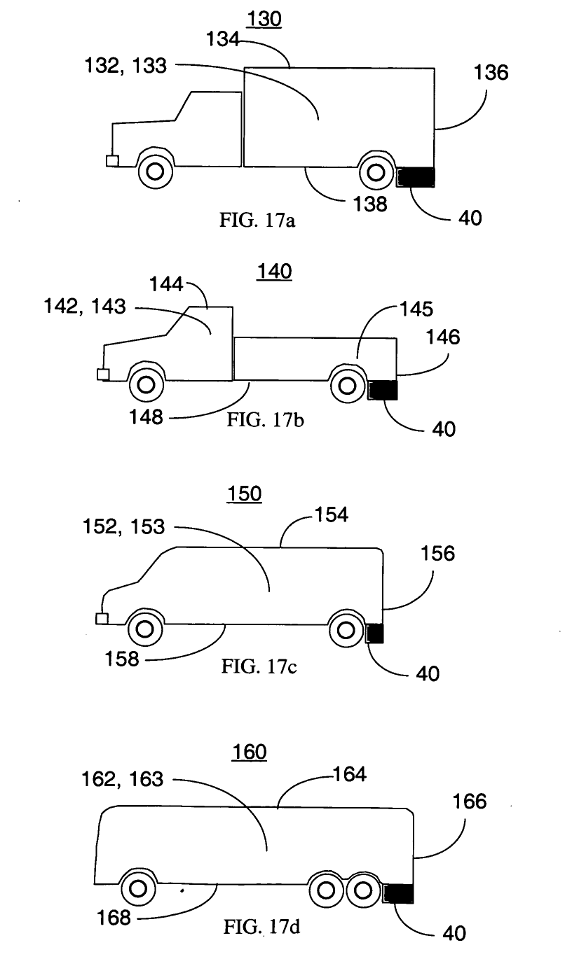

FIGS. 17a to 17d are side views of various embodiments of the subject invention 40 installed on various ground vehicles. FIG. 17a is a side view of a panel truck 130 with the subject invention 40 installed in the furthest aft position on the truck 130 lower surface 138. FIG. 17b is a side view of a pick-up truck 1 with the subject invention 40 installed on the pick-up bed lower surface 148. FIG. 17c is a side view of a van 150 with the subject invention 40 installed in an aft position on the van 150 lower surface 158. FIG. 17d is a side view of a bus 160 with the subject invention 40 installed in the aft position on the bus 160 lower surface 168.

### ADVANTAGES

From the description provided above, a number of advantages of the vortex strakes become evident:

The invention provides a novel process to reduce the drag of a bluff-base body.
(a) The invention provides a means to use aerodynamically shaped surfaces mounted on the lower surface of a bluff-base body to add momentum to the undercarriage flow to reduce drag.
(b) The invention provides a means to reduce the aerodynamic drag and improve the operational efficiency of bluff-base vehicles.
(c) The invention provides a means to reduce the aerodynamic drag and improve the fuel efficiency of bluff-base vehicles.
(d) The invention provides a means to conserve energy and improve the operational efficiency of bluff-base vehicles.
(e) The invention provides a means to reduce the aerodynamic drag without a significant geometric modification to existing bluff-base vehicles.
(f) The invention may be easily applied to any existing bluff-base vehicle or designed into any new bluff-base vehicle.
(g) The invention allows for the efficient operation of the invention with a limited number of surfaces.
(h) The invention allows for the matching of complex surface shapes by the shaping and placement of the lower surface mounted device.
(i) Large reductions in drag force can be achieved by the addition of momentum.
(j) The structure of each surface may be adapted to meet specific performance or vehicle integration requirements.
(k) The shape of each surface may be planar, cylindrical, or combinations thereof to meet specific performance or vehicle integration requirements.
(l) The ability to optimally position each surface on the vehicle lower surface.
(m)The ability to minimize weight and volume requirements within the vehicle.
(n) The ability to minimize maintenance requirements.
(o) The ability to maximize the safety of vehicle operation.

### CONCLUSION, RAMIFICATIONS, AND SCOPE

Accordingly, the reader will see that the undercarriage flow control device can be used to easily and conveniently reduce aerodynamic drag on any ground vehicle for the purposes of improving the operational performance of the vehicle. Furthermore, the surfaces comprising the undercarriage flow control device has the additional advantages in that:
it provides an aerodynamic drag reduction force over the base of the vehicle;
it allows the contour of the host surface to be easily matched;
it allows easy application to any existing vehicle or designed into any existing vehicle;
it allows the device to be fabricated as an independent unit that may be applied to an existing surface;
it allows for optimal positioning of each surface on the vehicle lower surface;
it allows the design of a system with minimum weight and requires minimum volume within the vehicle;
it allows minimum maintenance requirements;
it allows for the maximum safety of vehicle operation;

Although the description above contains many specificities, these should not be construed as limiting the scope of the invention but as merely providing illustrations of some of the presently preferred embodiments of this invention. For example, the side surfaces can have various planar and non-planar shapes; the thickness and width can vary along the length; the material can be any light-weight and structurally sound material such as rubber, plastic, metal, composites, etc.; the substrate can be any metal, wood, plastic, composite, rubber, ceramic, etc.; the application surface can be that of a metal, wood, plastic, composite, rubber, ceramic, etc.

The invention has been described relative to specific embodiments thereof and relative to specific vehicles, it is not so limited. The invention is considered applicable to any road vehicle including automobiles, trucks, buses, trains, recreational vehicles and campers. The invention is also considered applicable to non-road ground-effect vehicles such as hovercraft and components of these vehicles. It is to be understood that various modifications and variation of the specific embodiments described herein will be readily apparent to those skilled in the art in light of the above teachings without departing from the spirit and scope.

Thus, the scope of the invention should be determined by the appended claims and their legal equivalents, rather than by the examples given.

1. An aerodynamic drag reduction device for use on a ground vehicle comprising:
a nozzle comprising;
a nozzle upper surface comprising the lower exterior surface of said ground vehicle,
a nozzle lower surface comprising the road or structure on which said ground vehicle is traveling,
a nozzle first and second exterior side surface,
a means for attaching said nozzle first and second exterior side surfaces to said ground vehicle,
said nozzle first and second exterior side surfaces are laterally opposing surfaces attached in proximity to the aft lower exterior surface of said ground vehicle,
said nozzle first and second exterior side surfaces are positioned between the base area and the aft most set of wheels of said ground vehicle,
said nozzle first and second exterior side surfaces are symmetrically positioned about the vertical plane of symmetry of said ground vehicle,
said nozzle first and second exterior side surfaces are located at approximately the same vertical position of said ground vehicle,
said nozzle first and second exterior side surfaces are located at approximately the same longitudinal position of said ground vehicle,
each of said nozzle first and second exterior side surfaces has an upper edge that is attached in proximity to the said lower exterior surface of said ground vehicle,
each of said nozzle first and second exterior side surfaces has a lower edge that is vertically located below the said upper edge,
each of said nozzle first and second exterior side surfaces extends downward from the said vehicle lower exterior surface a majority of the distance to the ground or structure on which said ground vehicle is traveling,
each of said nozzle first and second exterior side surfaces has a forward edge that is longitudinally positioned immediately aft of the rear most set of wheels on said ground vehicle,
each of said nozzle first and second exterior side surfaces forward edge is laterally positioned approximately coincident with the most outward facing wheel surface of said ground vehicle,
each of said nozzle first and second exterior side surfaces has a rear edge that is longitudinally positioned immediately forward of the base area of said ground vehicle,
each of said nozzle first and second exterior side surfaces rear edge is laterally positioned inboard of the said forward edge of said nozzle first and second exterior side surfaces a distance between 10% and 40% of the said ground vehicle width,
each of said nozzle first and second exterior side surfaces have a thickness less than 1.0 inches,
each of said nozzle first and second exterior side surfaces may vary in forward extent,
each of said nozzle first and second exterior side surfaces may vary in rearward extent,
each of said nozzle first and second exterior side surfaces may vary in vertical extent,
each of said nozzle first and second exterior side surfaces being attached in close proximity to the said ground vehicle and being separated from one another allow each said nozzle first and second exterior side surfaces to interact with the flow passing under the said ground vehicle and allow said nozzle first and second exterior side surfaces to act as a means to increase the momentum of the flow passing under the said ground vehicle and allow said nozzle first and second exterior side surfaces to discharge the flow into the said ground vehicle trailing wake thereby the asymmetric character of the exterior trailing wake flow field is changed to a substantially steady and laterally symmetric flow field.

2. An aerodynamic drag reduction device of claim 1 wherein said nozzle lower surface is attached to the said nozzle first and second exterior side surfaces.

3. An aerodynamic drag reduction device of claim 1 wherein said nozzle first and second exterior side surfaces are rigid.

4. An aerodynamic drag reduction device of claim 1 wherein said nozzle first and second exterior side surfaces are flexible.

5. An aerodynamic drag reduction device of claim 1 wherein said nozzle first and second exterior side surfaces are comprised of both flexible and rigid material.

6. An aerodynamic drag reduction device of claim 1 wherein said nozzle first and second exterior side surfaces are constructed as a single element and attached to the said ground vehicle.

7. An aerodynamic drag reduction device of claim 1 wherein said nozzle first and second exterior side surfaces are an assembly of multiple components and attached to the said ground vehicle.

8. An aerodynamic drag reduction device of claim 1 wherein said nozzle first and second exterior side surfaces are constructed as an integral part of the said ground vehicle.

9. An aerodynamic drag reduction device of claim 1 wherein the downward extent of each said nozzle first and second exterior side surfaces varies from a maximum at the forward edge to a minimum at the rear edge.

10. An aerodynamic drag reduction device of claim 1 wherein the vertical alignment of each said nozzle first and second exterior side surfaces varies with the lower edge positioned inboard of the upper edge.

11. An aerodynamic drag reduction device of claim 1 wherein the downward extent of each said nozzle first and second exterior side surfaces varies from a maximum at the forward edge to a minimum at the rear edge and the vertical alignment of the said nozzle first and second exterior side surfaces vary with the lower edge positioned inboard of the upper edge.

12. An aerodynamic drag reduction device of claim 1 wherein said nozzle first and second exterior side surfaces are curvilinear in the longitudinal direction.

13. An aerodynamic drag reduction device of claim 1 wherein said nozzle first and second exterior side surfaces are planar in both the vertical and longitudinal direction.

14. An aerodynamic drag reduction device of claim 1 wherein said nozzle first and second exterior side surfaces are comprised of multiple planar sections in both the vertical and longitudinal direction.

15. An aerodynamic drag reduction device for a ground vehicle comprising:
a nozzle comprising;
a nozzle upper surface comprising the lower exterior surface of said ground vehicle,
a nozzle lower surface comprising the road or structure on which said ground vehicle is traveling,
a nozzle first and second exterior side surface,
said nozzle first and second exterior side surfaces are laterally opposing surfaces in proximity to the aft lower exterior surface of said ground vehicle,
said nozzle first and second exterior side surfaces are located between the base area and the aft most set of wheels of said ground vehicle,
said nozzle first and second exterior side surfaces are symmetrically located about the vertical plane of symmetry of said ground vehicle,
said nozzle first and second exterior side surfaces are located at approximately the same vertical position of said ground vehicle,
said nozzle first and second exterior side surfaces are located at approximately the same longitudinal position of said ground vehicle,
each of said nozzle first and second exterior side surfaces has an upper edge in proximity to the said lower exterior surface of said ground vehicle,
each of said nozzle first and second exterior side surfaces has a lower edge that is vertically located below the said upper edge,
each of said nozzle first and second exterior side surfaces extends downward from the said vehicle lower exterior surface a majority of the distance to the ground or structure on which said ground vehicle is traveling,
each of said nozzle first and second exterior side surfaces has a forward edge that is longitudinally positioned immediately aft of the rear most set of wheels on said ground vehicle,
each of said nozzle first and second exterior side surfaces forward edge is laterally positioned approximately coincident with the most outward facing wheel surface of said ground vehicle,
each of said nozzle first and second exterior side surfaces has a rear edge that is longitudinally positioned immediately forward of the base area of said ground vehicle,
each of said nozzle first and second exterior side surfaces rear edge is laterally positioned inboard of the said forward edge of said nozzle first and second exterior side surfaces a distance between 10% and 40% of the said ground vehicle width,
each of said nozzle first and second exterior side surfaces have a thickness less than 1.0 inches,
each of said nozzle first and second exterior side surfaces may vary in forward extent,
each of said nozzle first and second exterior side surfaces may vary in rearward extent,
each of said nozzle first and second exterior side surfaces may vary in vertical extent,
each of said nozzle first and second exterior side surfaces being in close proximity to the said ground vehicle and being separated from one another allow each said nozzle first and second exterior side surfaces to interact with the flow passing under the said ground vehicle and allow said nozzle first and second exterior side surfaces to act as a means to increase the momentum of the flow passing under the said ground vehicle and allow said nozzle first and second exterior side surfaces to discharge the flow into the said ground vehicle trailing wake thereby the asymmetric character of the exterior trailing wake flow field is changed to a substantially steady and laterally symmetric flow field and drag of said ground vehicle is reduced.

16. An aerodynamic drag reduction device of claim 15 wherein said nozzle lower surface is attached to the said nozzle first and second exterior side surfaces.

17. An aerodynamic drag reduction device of claim 15 wherein said nozzle first and second exterior side surfaces are rigid.

18. An aerodynamic drag reduction device of claim 15 wherein said nozzle first and second exterior side surfaces are flexible.

19. An aerodynamic drag reduction device of claim 15 wherein said nozzle first and second exterior side surfaces are comprised of both flexible and rigid material.

20. An aerodynamic drag reduction device of claim 15 wherein said nozzle first and second exterior side surfaces are constructed as an integral part of the said ground vehicle.

21. An aerodynamic drag reduction device of claim 15 wherein the downward extent of each said nozzle first and second exterior side surfaces varies from a maximum at the forward edge to a minimum at the rear edge.

22. An aerodynamic drag reduction device of claim 15 wherein the vertical alignment of each said nozzle first and second exterior side surfaces varies with the lower edge positioned inboard of the upper edge.

23. An aerodynamic drag reduction device of claim 15 wherein the downward extent of each said nozzle first and second exterior side surfaces varies from a maximum at the forward edge to a minimum at the rear edge and the vertical alignment of the said nozzle first and second exterior side surfaces vary with the lower edge positioned inboard of the upper edge.

24. An aerodynamic drag reduction device of claim 15 wherein said nozzle first and second exterior side surfaces are curvilinear in the longitudinal direction.

25. An aerodynamic drag reduction device of claim 15 wherein said nozzle first and second exterior side surfaces are planar in both the vertical and longitudinal direction.

26. An aerodynamic drag reduction device of claim 15 wherein said nozzle first and second exterior side surfaces are comprised of multiple planar sections in both the vertical and longitudinal direction.

27. An method for reducing the aerodynamic drag of a ground vehicle comprising the steps of:
modifying the lower exterior surface of said ground vehicle to produce a nozzle,
said nozzle has an upper surface comprising the lower exterior surface of said ground vehicle,
said nozzle has a lower surface comprising the road or structure on which said ground vehicle is traveling,
said nozzle has first and second exterior side surfaces,
said nozzle first and second exterior side surfaces are laterally opposing surfaces in proximity to the aft lower exterior surface of said ground vehicle,
said nozzle first and second exterior side surfaces are located between the base area and the aft most set of wheels of said ground vehicle,
said nozzle first and second exterior side surfaces are symmetrically located about the vertical plane of symmetry of said ground vehicle,
said nozzle first and second exterior side surfaces are located at approximately the same vertical position of said ground vehicle,
said nozzle first and second exterior side surfaces are located at approximately the same longitudinal position of said ground vehicle,
each of said nozzle first and second exterior side surfaces has an upper edge in proximity to the said lower exterior surface of said ground vehicle,
each of said nozzle first and second exterior side surfaces has a lower edge that is vertically located below the said upper edge,
each of said nozzle first and second exterior side surfaces extends downward from the said vehicle lower exterior surface a majority of the distance to the ground or structure on which said ground vehicle is traveling,
each of said nozzle first and second exterior side surfaces has a forward edge that is longitudinally positioned immediately aft of the rear most set of wheels on said ground vehicle,
each of said nozzle first and second exterior side surfaces forward edge is laterally positioned approximately coincident with the most outward facing wheel surface of said ground vehicle,
each of said nozzle first and second exterior side surfaces has a rear edge that is longitudinally positioned immediately forward of the base area of said ground vehicle,
each of said nozzle first and second exterior side surfaces rear edge is laterally positioned inboard of the said forward edge of said nozzle first and second exterior side surfaces a distance between 10% and 40% of the said ground vehicle width,
each of said nozzle first and second exterior side surfaces have a thickness less than 1.0 inches,
each of said nozzle first and second exterior side surfaces may vary in forward extent,
each of said nozzle first and second exterior side surfaces may vary in rearward extent,
each of said nozzle first and second exterior side surfaces may vary in vertical extent,
each of said nozzle first and second exterior side surfaces being in close proximity to the said ground vehicle and being separated from one another allow each said nozzle first and second exterior side surfaces to interact with the flow passing under the said ground vehicle and allow said nozzle first and second exterior side surfaces to act as a means to increase the momentum of the flow passing under the said ground vehicle and allow said nozzle first and second exterior side surfaces to discharge the flow into the said ground vehicle trailing wake thereby the asymmetric character of the exterior trailing wake flow field is changed to a substantially steady and laterally symmetric flow field and drag of said ground vehicle is reduced.

28. An aerodynamic drag reduction device of claim 27 wherein said nozzle lower surface is attached to the said nozzle first and second exterior side surfaces.

29. An method for reducing the aerodynamic drag of a ground vehicle comprising the steps of:
attaching to the exterior lower surface of said ground vehicle a nozzle comprising;
a nozzle upper surface comprising the lower exterior surface of said ground vehicle,
a nozzle lower surface comprising the road or structure on which said ground vehicle is traveling,
a nozzle first and second exterior side surface,
said nozzle first and second exterior side surfaces are laterally opposing surfaces attached in proximity to the aft lower exterior surface of said ground vehicle,
said nozzle first and second exterior side surfaces are positioned between the base area and the aft most set of wheels of said ground vehicle,
said nozzle first and second exterior side surfaces are symmetrically positioned about the vertical plane of symmetry of said ground vehicle,
said nozzle first and second exterior side surfaces are located at approximately the same vertical position of said ground vehicle,
said nozzle first and second exterior side surfaces are located at approximately the same longitudinal position of said ground vehicle,
each of said nozzle first and second exterior side surfaces has an upper edge that is attached in proximity to the said lower exterior surface of said ground vehicle,
each of said nozzle first and second exterior side surfaces has a lower edge that is vertically located below the said upper edge,
each of said nozzle first and second exterior side surfaces extends downward from the said vehicle lower exterior surface a majority of the distance to the ground or structure on which said ground vehicle is traveling,
each of said nozzle first and second exterior side surfaces has a forward edge that is longitudinally positioned immediately aft of the rear most set of wheels on said ground vehicle,
each of said nozzle first and second exterior side surfaces forward edge is laterally positioned approximately coincident with the most outward facing wheel surface of said ground vehicle,
each of said nozzle first and second exterior side surfaces has a rear edge that is longitudinally positioned immediately forward of the base area of said ground vehicle,
each of said nozzle first and second exterior side surfaces rear edge is laterally positioned inboard of the said forward edge of said nozzle first and second exterior side surfaces a distance between 10% and 40% of the said ground vehicle width,
each of said nozzle first and second exterior side surfaces have a thickness less than 1.0 inches,
each of said nozzle first and second exterior side surfaces may vary in forward extent,
each of said nozzle first and second exterior side surfaces may vary in rearward extent,
each of said nozzle first and second exterior side surfaces may vary in vertical extent,
each of said nozzle first and second exterior side surfaces being in close proximity to the said ground vehicle and being separated from one another allow each said nozzle first and second exterior side surfaces to interact with the flow passing under the said ground vehicle and allow said nozzle first and second exterior side surfaces to act as a means to increase the momentum of the flow passing under the said ground vehicle and allow said nozzle first and second exterior side surfaces to discharge the flow into the said ground vehicle trailing wake thereby the asymmetric character of the exterior trailing wake flow field is changed to a substantially steady and laterally symmetric flow field.

30. An aerodynamic drag reduction device of claim 29 wherein said nozzle lower surface is attached to the said nozzle first and second exterior side surfaces.

30.
